(19) United States
(12) Patent Application Publication
(10) Pub. No.: US 2026/0227500 A1
(43) Pub. Date: Aug. 6, 2026

(54) SYSTEMS AND METHODS FOR MULTI-MODAL OCCUPANCY DETECTION USING ACTIVE ASSET TAGS

(71) Applicant: Cisco Technology, Inc., San Jose, CA (US)

(72) Inventors: Peiman Amini, Fremont, CA (US); Navid Reyhanian, Santa Clara, CA (US); Niloo Bahadori, Greensboro, NC (US); Ardalan Alizadeh, Campbell, CA (US); Jerome Henry, Pittsboro, NC (US)

(21) Appl. No.: 19/530,201

(22) Filed: Feb. 4, 2026

Related U.S. Application Data
(60) Provisional application No. 63/753,918, filed on Feb. 4, 2025.

(51) Int. Cl. G01S 13/46; G01S 7/41; G01S 13/02

(52) U.S. Cl. CPC G01S 13/46; G01S 7/417; G01S 13/0209; G01S 2013/462

(57) ABSTRACT

Systems and methods for multi-modal occupancy detection using active asset tags are described that utilize existing network infrastructure and battery-powered tags to perform environmental sensing without dedicated motion sensors. An active asset tag equipped with an accelerometer and wireless transceivers monitors its physical state to distinguish between self-motion and environmental occupancy. When stationary, the tag analyzes signal characteristics, such as Bluetooth Low Energy (BLE) attenuation or Ultra-Wideband (UWB) channel impulse responses, using an onboard artificial intelligence engine to detect human presence. The system also employs a bistatic radar framework where access points measure multipath reflections from tag transmissions to locate and count occupants. To optimize power consumption, a hybrid sensing logic utilizes low-power BLE scanning to trigger high-precision UWB ranging only when anomalies are detected. Aggregated data from the distributed sensing nodes is processed by a cloud-based analytics service to generate real-time occupancy maps and utilization insights for facility management.

### PRIORITY

This application claims the benefit and priority to U.S. Provisional Application No. 63/753,918, filed Feb. 4, 2025, which is incorporated in its entirety herein.

### TECHNICAL FIELD

The present disclosure relates to wireless network sensing and environmental monitoring systems. More particularly, the present disclosure relates to utilizing active asset tags equipped with multi-modal wireless transceivers as environmental sensors to detect occupancy and motion within a physical space.

### BACKGROUND

In modern enterprise and industrial environments, understanding how physical spaces are utilized is critical for optimizing operations, energy consumption, and safety. Building managers often seek real-time insights into room occupancy to automate lighting and HVAC systems, ensuring resources are not wasted on empty spaces. Furthermore, in sectors such as healthcare and logistics, the ability to track the location of high-value assets, such as medical equipment or inventory pallets, is essential for workflow efficiency and inventory control. Traditionally, achieving both occupancy detection and asset tracking has required the deployment of disparate, dedicated infrastructure systems. For instance, asset tracking often relies on specific tags and readers, while occupancy detection typically necessitates separate motion sensors, cameras, or infrared counters installed throughout a facility.

Deploying and maintaining these separate systems can be costly and complex, often resulting in redundant hardware and increased administrative overhead. Dedicated sensors for occupancy, such as cameras, may also raise privacy concerns among occupants, limiting their deployment in sensitive areas. Moreover, traditional Radio Frequency (RF) based tracking solutions often struggle to distinguish between the movement of the tracking tag itself and the movement of people within the environment, potentially leading to inaccurate data regarding space usage. Consequently, there is a desire for integrated solutions that can leverage existing network infrastructure to provide accurate, multi-purpose sensing capabilities without the need for extensive additional hardware.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting various subsets of artificial intelligence in accordance with various embodiments of the disclosure;

FIG. 2 are conceptual illustrations depicting different methods of machine-based learning in accordance with various embodiments of the disclosure;

FIG. 3 is a conceptual illustration depicting a machine learning lifecycle in accordance with various embodiments of the disclosure;

FIG. 4 is a conceptual illustration depicting an exemplary neural network in accordance with various embodiments of the disclosure;

FIG. 5 is a schematic diagram of a system architecture for multi-modal occupancy detection illustrating signal paths between an active asset tag, a target, and an access point in accordance with various embodiments of the disclosure;

FIG. 6 is a network diagram illustrating a network topology for aggregating occupancy data from active asset tags to a cloud analytics service in accordance with various embodiments of the disclosure;

FIG. 7 is a perspective view of a physical environment illustrating bistatic radar vector paths between a reference tag, a target, and a receiver in accordance with various embodiments of the disclosure;

FIG. 8 is a plan view of an environment illustrating different wireless coverage zones for hybrid occupancy monitoring in accordance with various embodiments of the disclosure;

FIG. 9 is a block diagram of an active asset tag configured for multi-modal sensing in accordance with various embodiments of the disclosure;

FIG. 10 is a flowchart showing a process for determining an occupancy state on an asset tag based on motion awareness in accordance with various embodiments of the disclosure;

FIG. 11 is a flowchart showing a process for detecting occupancy using ultra-wideband radar signals in accordance with various embodiments of the disclosure;

FIG. 12 is a flowchart showing a process for triggering high-precision ranging based on low-power monitoring in accordance with various embodiments of the disclosure;

FIG. 13 is a flowchart showing a process for preprocessing wireless signal data for feature extraction in accordance with various embodiments of the disclosure;

FIG. 14 is a flowchart showing a process for training and updating occupancy detection models in accordance with various embodiments of the disclosure;

FIG. 15 is a diagram illustrating a deployment of occupancy determination logic across local, edge, and remote layers in accordance with various embodiments of the disclosure; and

FIG. 16 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, an asset tag, includes a processor, an accelerometer, a wireless transceiver, and a memory communicatively coupled to the processor, wherein the memory includes an occupancy detection logic. The logic is configured to monitor inertial data generated by the accelerometer, determine a stationary state based on the inertial data, measure, via the wireless transceiver, signal characteristics of a wireless signal, apply an onboard machine learning classification model to the signal characteristics, determine an occupancy presence based on the output of the machine learning classification model, and transmit, via the wireless transceiver, an occupancy notification based on the determined occupancy presence.

In some embodiments, a method of occupancy detection includes receiving, by a network device via an ultra-wideband transceiver, a signal located in an environment, extracting, by the network device, a channel impulse response from the received signal, determining, by the network device, a difference between the channel impulse response to a baseline environmental signature associated with the environment, detecting, by the network device, based on the difference, a multipath disturbance, and updating, by the network device, an occupancy status for the environment based on the detected multipath disturbance.

### EXAMPLE EMBODIMENTS

In response to the problems and issues described, embodiments of the present disclosure provide systems and methods for multi-modal occupancy detection using active asset tags. Conventional systems typically require separate, siloed hardware infrastructures for tracking high-value assets and monitoring room occupancy, leading to increased installation costs and maintenance complexity. To address these limitations, the present disclosure utilizes a unified infrastructure where wireless asset tracking tags serve a dual purpose as environmental sensors. By leveraging the radio frequency signals already being transmitted for location tracking, the system can detect disturbances in the wireless channel caused by human presence without the need for dedicated motion detectors or invasive cameras. This approach allows facility managers to utilize a single deployment of devices to achieve both asset visibility and real-time space utilization insights.

In many embodiments, the system solves the challenge of distinguishing between tag motion and environmental occupancy by integrating inertial measurement sensors directly into the wireless tags. A significant hurdle in traditional RF-based sensing is that a moving transmitter generates signal variances that mimic the patterns of a moving person, potentially causing false positives. To mitigate this, the disclosed asset tags are configured to monitor their own physical state using an onboard accelerometer to confirm they are stationary before initiating environmental sensing. Once the tag confirms it is at rest, it can safely interpret variations in received signal strength or channel impulse response as valid indicators of external activity. This self-awareness ensures that the generated occupancy data is reliable and accurate, filtering out noise caused by the normal operational movement of the assets themselves.

In various embodiments, the system transforms the standard communication network into a bistatic radar grid capable of high-precision localization and counting. Unlike traditional systems that rely solely on simple signal blocking or attenuation, the disclosed embodiments can analyze the multipath reflections of ultra-wideband pulses to pinpoint the location of a target. When an asset tag transmits a signal, the system measures not only the direct path to the access point but also the secondary paths that bounce off objects or people in the room. By calculating the time difference between these signal components, the system can mathematically derive the position of the occupant, enabling advanced features such as headcount estimation and trajectory tracking within specific zones of interest. This capability provides a level of granularity that far exceeds simple presence detection, allowing for detailed analytics regarding how specific areas of a room are utilized.

In a number of embodiments, the system employs a hybrid sensing strategy to balance the competing requirements of high-fidelity detection and long operational battery life. Continuous high-precision radar sensing can drain the energy reserves of battery-powered tags rapidly, making such an approach impractical for large-scale deployments that require multi-year maintenance cycles. To overcome this, the disclosed solution utilizes low-power protocols, such as Bluetooth Low Energy, to perform continuous background monitoring for general presence detection. Only when a specific trigger condition is met, such as a significant signal anomaly or a scheduled query, does the system activate the power-intensive ultra-wideband radios to perform detailed ranging and classification. This dynamic resource allocation ensures that the system maximizes the useful lifespan of the hardware while still providing high-resolution data when it is most critical.

In further embodiments, the data collected from these distributed sensing nodes is aggregated and processed to provide actionable insights for facility management and automation. The system can feed the environmental signal data into machine learning models trained to recognize specific occupancy signatures, such as a person sitting at a desk versus walking through a hallway. Because the system relies on abstract radio frequency patterns rather than optical images, it inherently preserves the privacy of occupants while still providing granular utilization data. This architecture allows building managers to optimize heating, cooling, and lighting based on real-time usage patterns, ultimately creating a more energy-efficient and responsive physical environment. Furthermore, by continuously updating these models based on aggregated data, the system can adapt to changing environments and improve its detection accuracy over time without requiring hardware replacements.

In various embodiments, channel impulse responses can be understood as a comprehensive time-domain profile that characterizes how a wireless signal propagates through a specific physical environment from a transmitter to a receiver. When a radio wave is emitted, it rarely travels in a single, straight line; instead, it interacts with the surrounding architecture, furniture, and people, creating a complex pattern of reflections, diffractions, and scattering events. The channel impulse response captures this behavior by recording the arrival time, amplitude, and phase of the signal along every distinct path it takes to reach the receiver. This essentially creates a unique electromagnetic fingerprint of the space at a specific moment in time, where the earliest peak usually represents the direct line-of-sight path and subsequent peaks represent the delayed echoes bouncing off walls or objects.

Furthermore, the channel impulse response can serve as a useful data input for detecting changes within that space, functioning much like a sonar reading for the radio frequency spectrum. In the context of occupancy detection, a static room with no moving occupants will produce a consistent and stable channel impulse response over time because the fixed objects reflect signals in a predictable manner. However, when a person enters the environment, their body acts as a new reflector or absorber, altering the path of the signals and causing localized disturbances in the response profile. By continuously comparing the current channel impulse response against a baseline or historical average, the system can isolate these deviations to determine not just that a person is present, but potentially where they are located based on the time delay of the new reflection.

Often multipath propagation can be understood as the physical phenomenon where a wireless signal reaches a receiving antenna by two or more paths, causing the signal components to arrive at different times and angles. This occurs because radio waves do not simply stop when they hit an obstacle; they bounce off surfaces like floors, ceilings, metal cabinets, and human bodies, creating a web of signal trajectories that fill the three-dimensional space. In traditional telecommunications, multipath propagation is often viewed as a nuisance that causes fading or interference, confusing the receiver and degrading data transfer rates. However, in the context of environmental sensing, this phenomenon is intentionally exploited as a rich source of information regarding the physical composition of the room.

Moreover, the specific characteristics of multipath propagation can provide the mathematical basis for distinguishing between static background clutter and dynamic human targets. Because the speed of light is constant, the extra distance traveled by a reflected signal compared to the direct signal results in a precise and measurable time delay. When a person moves through a room, they continuously alter the geometry of these reflection paths, causing the multipath components to shift in time and amplitude. The sensing system analyzes these shifts to calculate the position of the disturbance, effectively using the multipath reflections as virtual sensors that probe areas of the room that might be blocked from the direct line of sight of the access point.

Those skilled in the art will recognize that bistatic sensing refers to a radar or sensing configuration where the transmitter and the receiver are separated by a significant distance, rather than being co-located in the same unit as in traditional monostatic radar. In this configuration, the geometry of detection is defined by a triangle formed between the transmitter, the target, and the receiver, rather than a simple out-and-back round trip. This separation allows the system to utilize lightweight, battery-operated devices, such as asset tags, as the illuminators or transmitters, while utilizing more powerful, grid-connected infrastructure devices, such as access points, to act as the sensitive receivers that process the return signals.

Additionally, bistatic sensing introduces unique geometric properties that are advantageous for indoor localization and occupancy counting. The total distance traveled by a signal reflected off a target in a bistatic system defines an ellipsoid surface with the transmitter and receiver at the foci, meaning the target must lie somewhere on that surface. By combining measurements from multiple receiver-transmitter pairs, the system can intersect these ellipsoids to pinpoint the exact three-dimensional coordinates of the occupant. This topology is particularly effective in complex indoor environments because it provides diverse viewing angles of the target, reducing the likelihood that a person will be completely shadowed or hidden from detection behind a large obstacle.

In many embodiments, ultra-wideband technology can be defined as a radio transmission protocol that uses extremely short pulses of energy, often lasting less than a nanosecond, spread over a very large bandwidth of the radio spectrum. Unlike narrowband systems such as Wi-Fi or Bluetooth that modulate a continuous carrier wave, ultra-wideband relies on the precise timing of these pulses to convey information and measure distance. The broad spectral width of the signal renders it highly resistant to interference from other wireless devices and allows it to penetrate solid objects more effectively, making it ideal for robust communication in dense industrial or commercial environments.

Furthermore, the high temporal resolution of ultra-wideband technology is the critical enabler for the fine-grained sensing capabilities described herein. Because the pulses are so short, the receiver can distinguish between two signal paths that arrive only fractionally apart in time, allowing it to resolve reflections that are spaced just centimeters from each other. This capability stands in contrast to narrowband signals, where the reflections often merge into a single, muddy reading that obscures detail. This distinct separation of signal paths allows the system to separate the strong reflection from a wall from the weaker reflection of a person standing just a few feet away, providing the fidelity necessary for accurate headcount estimation and trajectory tracking.

In various embodiments, the system comprises a network device having a processor and a memory communicatively coupled to the processor, wherein the memory stores logic to detect occupancy. This logic extracts a channel impulse response from a signal and analyzes it to establish a correlation with a potential object in the environment. To determine the specific location of the object, the system calculates a position by solving a set of non-linear equations using known constraints. This process may involve generating a distinct position solution based on the data. The logic may effectively model the environment by utilizing non-linear optimization techniques to resolve the non-linear equations derived from the signal time-of-flight data. Furthermore, the system may apply neural networks to analyze the differences in signal signatures to confirm the correlation between the detected multipath disturbance and a human presence.

Complementing the network device is an asset tag having a memory communicatively coupled to a processor, configured to monitor signals from an external device. The tag evaluates signal characteristics that include at least one of a received signal strength indicator or channel state information. The tag is designed to trigger specific actions, such as increasing a sampling rate, in response to a variance in these signals exceeding a predefined threshold. Additionally, the tag logic may initiate transmission of ranging signals upon the variance exceeding another predefined criteria. The tag includes components communicatively coupled to the processor, including at least one wireless transceiver. The network device, which also has a memory communicatively coupled to its processor, operates by comparing received data against a predefined baseline signature, a predefined environmental model, or other predefined parameters to accurately update the occupancy status.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many other acquired instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and acquired features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

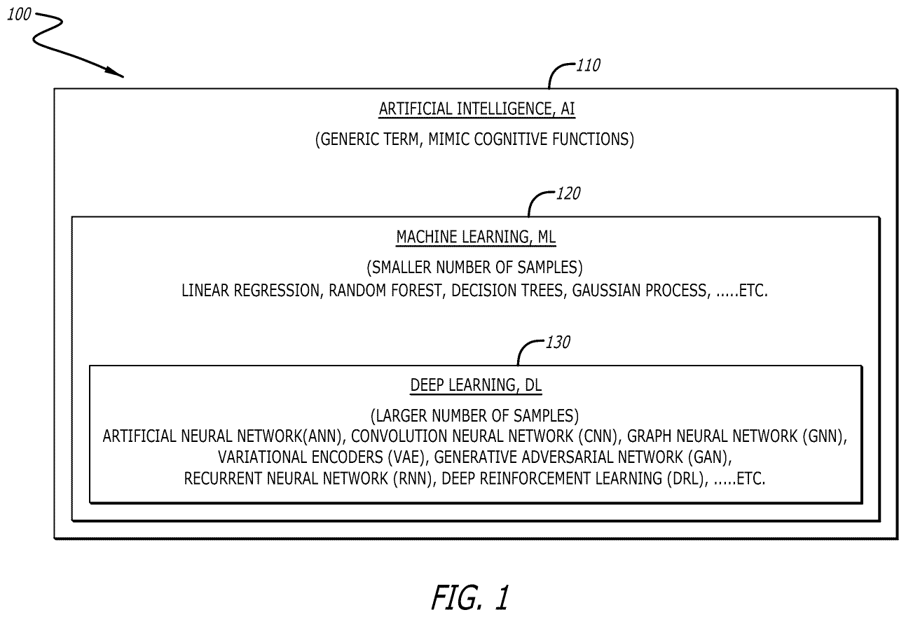

Referring to FIG. 1, a diagram 100 depicting various subsets of artificial intelligence in accordance with various embodiments of the disclosure is shown. Artificial intelligence (AI 110) is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML 120) allows computers to learn from data patterns without explicit programming for each task, while natural language processing (NLP) enables machines to understand and generate human language. Deep learning (DL 130), a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML 120) is a subset of Artificial Intelligence (AI 110) that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to analyze wireless signals such as channel impulse responses or received signal strength indicators to detect occupancy within an environment.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical occupancy logs, sensor validation data, simulated environmental models, among other sources.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than one-hundred) to learn effectively.

Deep Learning (DL 130) is a specialized subset of Machine Learning (ML 120) that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over five-hundred samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 120 neural network designed to work particularly well with image data, making them highly relevant for processing visual representations of signal propagation or heatmaps. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying an occupancy state or determining the number of people in a room.

While CNNs are well-suited for grid-based data like images, many real-world problems in can involve non-grid data, such as distributed sensor networks, signal paths, or device interactions. This type of data may better be represented as a graph, where nodes represent entities (e.g., asset tags or access points) and edges represent relationships between them (e.g., signal strength or distance). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an asset tag or the properties of a wireless channel.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct a potential occupancy scenario or simulate signal interference patterns.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to generate synthetic training data for rare occupancy events to improve model robustness.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex sensor data simulations.

In environmental sensing applications, DRL can be used in scenarios where an optimal decision needs to be made, such as optimizing a sampling rate or finding the best configuration for a multi-modal sensing network based on the desired or current properties of the devices. The combination of RL and DL can allow for learning from raw data, making it a powerful tool for dynamic and real-time decision-making within an occupancy detection system.

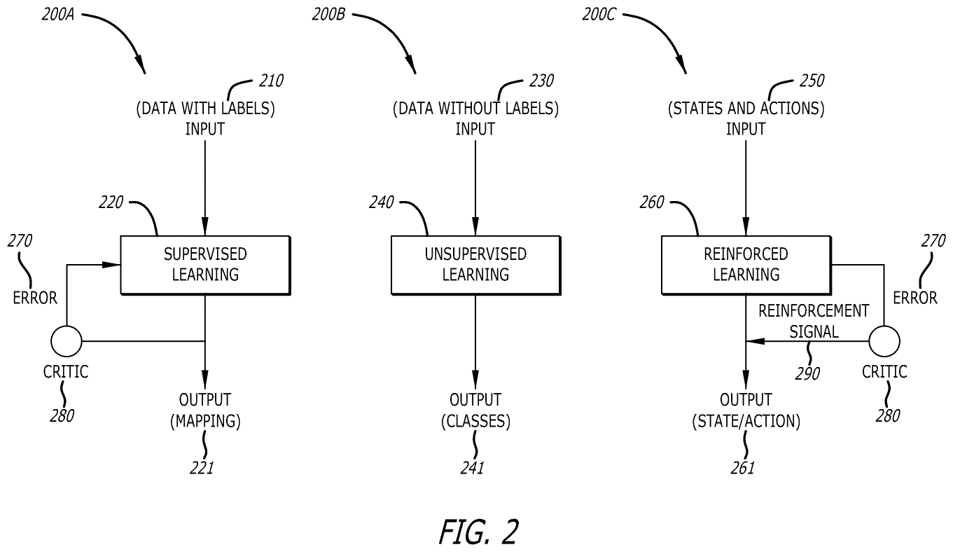

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subset may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-16 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 via one or more reinforcement signals 290 for use in updating.

A supervised learning system 200A can often be considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

A supervised learning system 200A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to various signal threshold options and the resulting classification of the occupancy state. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain signal pattern is suitable for occupancy detection, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = ( P ( X \vert y ) * P ( y ) ) / ( P ( X ) )$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on signal strength, time of flight, channel characteristics, etc.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. An unsupervised learning model 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision. In various embodiments, an unsupervised learning model 240 can often be utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate an occupancy prediction with a maximized confidence score. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice one or more errors 270 within the reinforcement learning model 260 actions, and adjust the outcome/output such that the “reward” or “punishment” is adjusted to better model the future behaviors or processing of the reinforcement learning model 260.

It is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-16 as required to realize a particularly desired embodiment.

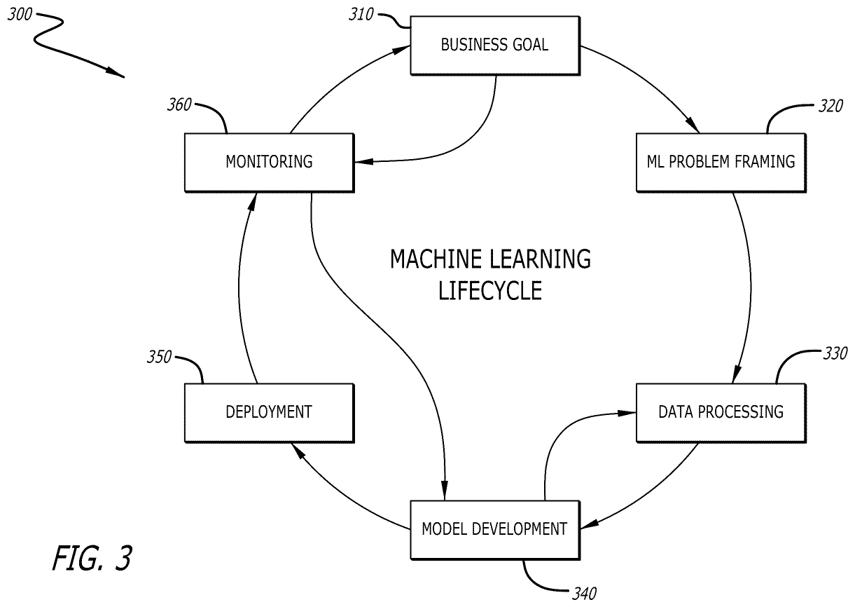

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A business goal 310 that is clear can ensure that the project remains focused on delivering tangible value, whether it is optimizing facility usage, reducing energy consumption, enhancing security, or automating headcount reports. Without a well-defined goal, it can be challenging to align the subsequent stages of the machine learning lifecycle 300, as the choice of model, data processing methods, and performance metrics can all depend on what the business aims to achieve.

Establishing a business goal 310 properly can also involve engaging with key stakeholders and developers to gather requirements and set success criteria. It can provide a roadmap that outlines what success looks like and helps in framing the ML problem. For example, if the goal is to reduce false positive occupancy detections, the project might focus on building a classification model that better distinguishes between human movement and mechanical vibrations. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. For example, if the goal is to identify occupied rooms, the problem can be framed as a binary classification task where the model predicts whether a room is occupied or vacant based on sensor data. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

The deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By monitoring 360 continuously, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, such as data processing 330 and model development 340, to refine the model(s) as needed. This iterative process allows the machine learning system to adapt and maintain its alignment with the business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aid in development and refinement of different model(s). The elements depicted in FIG. 3 may also be interchangeable with other elements of FIGS. 1-2 and 4-16 as required to realize a particularly desired embodiment.

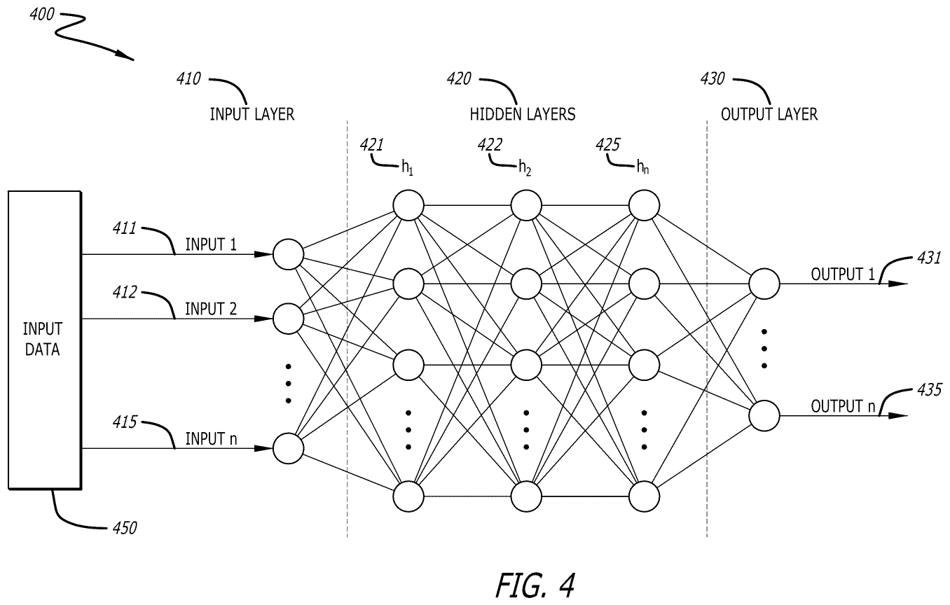

Referring to FIG. 4, a neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the one or more hidden layers 420 through weighted connections and activation functions. These one or more hidden layers 420 can enable the network to learn complex patterns and relationships within the data.

The output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding one or more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the one or more hidden layers 420 and output layer 430, the input layer 410 typically does not perform any computations or transformations on the data. Its primary function is often to pass the input data 450 to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing channel state information, signal strength readings, accelerometer data, or other data sources. For example, a model can be configured with a first input 411 configured as a first signal characteristic, a second input 412 is configured with a second signal characteristic, while additional inputs can be added related to the number of sensors in the system. The nth input 415 can be configured in certain embodiments to include the current occupancy state such that a determination to maintain the current state may be possible. However, as those skilled in the art will recognize, additional setups can be configured such that the inputs can be configured to also include different parameters of the tags, the number of access points, the historical variance of the signals, among other input types, etc.

In a number of embodiments, the neural network 400 comprises one or more hidden layers 420. The embodiment depicted in FIG. 4 comprises a first hidden layer 421, a second hidden layer 422, and an nth hidden layer 425, which are denoted as h₁, h₂, and hₙ respectively. In many embodiments, the one or more hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h₁ receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h₂, which builds upon the features identified by the first hidden layer 421. This deeper layer might start recognizing more complex patterns, such as shapes or specific object components, by combining the lower-level features identified earlier. This can continue on until a last, nth hidden layer 425 hₙ continues this abstraction process, allowing the network to recognize even higher-level, more detailed features, such as identifying an entire object within an image or understanding intricate relationships in the input data 450.

Each hidden layer adds a level of complexity and abstraction to the network's learning capabilities. The multi-layer structure can enable the network to move from recognizing simple patterns in the input layer 410 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the one or more hidden layers 420. Each neuron in the output layer 430 can represent a specific outcome or category that the model can predict. In the embodiment depicted in FIG. 4, the outputs are labeled as “output 1 431” to “output n 435,” indicating that the network can be designed to have a varying number of outputs depending on the nature of the problem being solved for. For example, in a binary classification task (e.g., occupied vs. vacant), there would typically be a single output neuron that provides a probability score for one of the two classes/outcomes. In contrast, for multi-class classification (e.g., categorizing occupancy density as low, medium, or high), the output layer would contain multiple neurons, each corresponding to a different class.

The number of neurons in the output layer 430 can also designed specifically for other types of tasks, such as regression, where the model can predict continuous values. In such cases, the output layer 430 might contain a single neuron representing a numerical prediction, such as the estimated headcount or the distance to a target, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-16 as required to realize a particularly desired embodiment.

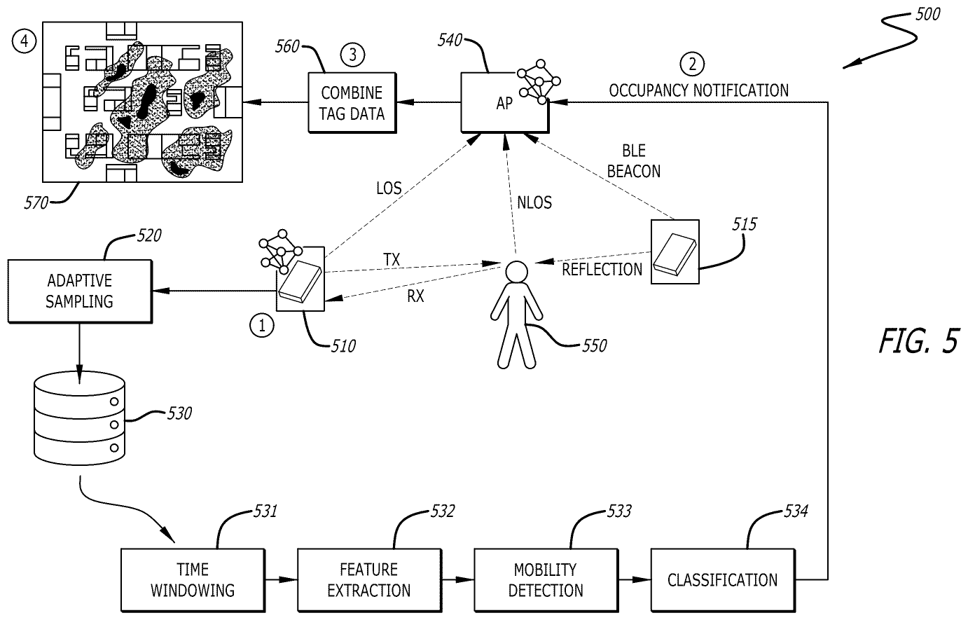

Referring to FIG. 5, a system architecture 500 for multi-modal occupancy detection illustrating signal paths between an active asset tag, a target, and an access point in accordance with various embodiments of the disclosure is shown. In many embodiments, the system architecture 500 can represent a physical environment, such as a conference room, hospital ward, or warehouse, where environmental sensing is required. The system architecture 500 can leverage existing wireless infrastructure to perform sensing functions without the need for dedicated motion sensors. Furthermore, the system architecture 500 generally illustrates the flow of data from the physical transmission of signals, through the propagation environment, to the reception and subsequent digital processing of those signals.

In various embodiments, the active asset tag 510 represents a portable computing device capable of transmitting wireless signals for both location tracking and environmental sensing. The active asset tag 510 can be attached to mobile equipment, such as a wheelchair, a crash cart, or an infusion pump, to track the equipment's location within a facility. In some embodiments, the active asset tag 510 is equipped with an onboard processor that allows it to perform local artificial intelligence or machine learning inference on the data it collects. Additionally, the active asset tag 510 can be configured to transmit multiple types of signals, including ultra-wideband blinks and Bluetooth low energy beacons, to facilitate different modes of occupancy detection.

In a number of embodiments, the passive asset 515 represents an object or device in the environment that may not possess the active sensing capabilities of the active asset tag 510. The passive asset 515 might be a tag configured only for transmission without onboard processing, or simply a physical object that reflects wireless signals. The passive asset 515 contributes to the multipath environment by creating additional signal reflections that can be measured by the system. Even without active processing, the presence and position of the passive asset 515 provide reference points that help the system distinguish between static environmental features and dynamic movements.

In many embodiments, the adaptive sampling module 520 functions as a logic controller that dynamically adjusts the rate at which signals are measured or transmitted. The adaptive sampling module 520 can monitor environmental variances to determine if the current sampling rate is sufficient for the level of activity in the room. If the environment is determined to be static, the adaptive sampling module 520 may reduce the sampling frequency to conserve the battery life of the active asset tag 510. Conversely, if a disturbance is detected, the adaptive sampling module 520 can increase the sampling rate to capture higher-fidelity data for precise classification.

In various embodiments, the time series dataset 530 serves as a storage structure for accumulating a history of signal measurements over a specific duration. The time series dataset 530 may contain a sequence of received signal strength indicator values or channel state information timestamps collected by the system. Maintaining this historical data allows the system to analyze trends and temporal patterns rather than relying solely on instantaneous measurements. This longitudinal view provided by the time series dataset 530 enables the detection of complex activities, such as walking or breathing, which manifest as periodic variations in the signal over time.

In some embodiments, the time windowing logic 531 is responsible for segmenting the continuous stream of data from the time series dataset 530 into discrete chunks for analysis. The time windowing logic 531 may apply a sliding window technique to isolate specific intervals of signal activity. By breaking the data into manageable windows, the time windowing logic 531 allows the subsequent processing stages to focus on localized signal behaviors. This segmentation is crucial for distinguishing between separate events or movements that may occur in close succession.

In further embodiments, the feature extraction logic 532 processes the segmented data to identify statistical or time-domain characteristics relevant to occupancy. The feature extraction logic 532 might calculate metrics such as the mean, variance, skewness, or kurtosis of the signal within a given window. Additionally, the feature extraction logic 532 may utilize dimensionality reduction techniques, such as principal component analysis, to simplify the data while retaining the most critical information. The output of the feature extraction logic 532 is a refined set of data points that highlights the disturbances caused by human presence.

In additional embodiments, the mobility detection logic 533 analyzes the extracted features to determine the movement status of the active asset tag 510 itself. The mobility detection logic 533 can utilize inertial data from an accelerometer to confirm whether the active asset tag 510 is stationary or in motion. Distinguishing self-motion from environmental motion is essential to prevent false positives where a moving tag might be mistaken for a moving person. The mobility detection logic 533 ensures that the occupancy detection algorithms are only applied or interpreted correctly when the reference frame is understood.

In still more embodiments, the classification logic 534 applies a machine learning model to the processed features to determine the current occupancy state. The classification logic 534 may utilize a decision tree, a random forest, or a neural network to categorize the signal patterns as indicative of “occupied” or “empty”. The classification logic 534 can be executed locally on the active asset tag 510 or remotely on a server depending on the complexity of the model. The output of the classification logic 534 is a definitive status or probability score regarding the presence of people in the monitored area.

In a number of embodiments, the access point 540 acts as the central infrastructure node that receives wireless transmissions from the devices in the environment. The access point 540 is equipped with the necessary radios to communicate via Wi-Fi, Bluetooth low energy, and ultra-wideband protocols. The access point 540 receives blink signals, beacon signals, and occupancy notifications transmitted by the active asset tag 510. Additionally, the access point 540 measures the physical characteristics of the received signals, such as the time of arrival and signal strength, which are used for the radar-based detection calculations.

In various embodiments, the target 550 represents a person or object within the environment whose presence the system intends to detect. The target 550 interacts with the wireless signals propagating through the room, creating reflections or blocking the line of sight between the active asset tag 510 and the access point 540. These physical interactions with the radio waves create the multipath disturbances and signal attenuation that the system measures. The target 550 does not need to carry any device or tag to be detected, as the detection is based on the passive reflection or absorption of signals by the target 550.

In some embodiments, the tag data combiner 560 functions to aggregate the various streams of information generated by the tags and the infrastructure. The tag data combiner 560 may merge the explicit occupancy notifications sent by the active asset tag 510 with the raw signal data measured by the access point 540. This aggregation allows the system to validate detection events using multiple sources of truth, such as confirming a radar-based detection with a Bluetooth-based signal drop. The tag data combiner 560 ensures that the final occupancy determination is robust and minimizes conflicting information.

In many embodiments, the occupancy map 570 serves as the visual or digital output representing the spatial utilization of the environment. The occupancy map 570 can display a heatmap or a set of coordinates indicating where people are located within the floor plan. The occupancy map 570 is generated based on the processed and combined data, providing facility managers with real-time insights into room usage. This output can be used to trigger building automation systems or simply to provide analytics on space efficiency.

As one example embodiment of operation within the system architecture 500, the active asset tag 510 may transmit an ultra-wideband blink signal that travels through the environment. A portion of this signal may travel directly to the access point 540 via a line-of-sight path, establishing a baseline arrival time. Simultaneously, another portion of the signal may strike the target 550 and bounce towards the access point 540 via a non-line-of-sight path. The access point 540 receives both signal components and extracts the channel impulse response, identifying the secondary peak caused by the reflection off the target 550. By analyzing the time difference between the direct path and the reflected path, the system can estimate the distance of the target 550 relative to the known positions of the active asset tag 510 and the access point 540.

In another example embodiment, the system architecture 500 may utilize the shadowing effect of the Bluetooth low energy signals to detect the target 550. The active asset tag 510 continuously broadcasts beacon signals that are monitored by the access point 540. When the target 550 walks between the active asset tag 510 and the access point 540, the body of the target 550 absorbs or blocks some of the signal energy. This results in a sudden drop in the received signal strength indicator value recorded in the time series dataset 530. The feature extraction logic 532 detects this drop as a significant variance, and the classification logic 534 interprets the pattern as a person passing through the zone.

In yet another example embodiment, the adaptive sampling module 520 optimizes the system by coordinating with the mobility detection logic 533. If the mobility detection logic 533 indicates that the active asset tag 510 is stationary, the adaptive sampling module 520 enters an environmental sensing mode. In this mode, the active asset tag 510 focuses on detecting changes in the external signal environment rather than updating its own location coordinates. However, if the mobility detection logic 533 detects that the active asset tag 510 is being moved, the adaptive sampling module 520 switches priority to asset tracking, potentially increasing the blink rate to ensure the equipment is not lost. This ensures that the limited battery resources are always directed toward the most relevant task for the current state of the device.

Although a specific embodiment for a system architecture 500 for carrying out the various steps, processes, methods, and operations described herein is discussed with respect to FIG. 5, any of a variety of systems and/or devices may be utilized in accordance with embodiments of the disclosure. For example, the access point 540 may be replaced by a dedicated IoT gateway or a network of listening nodes. The elements depicted in FIG. 5 may also be interchangeable with other elements of FIGS. 1-4 and 6-16 as required to realize a particularly desired embodiment.

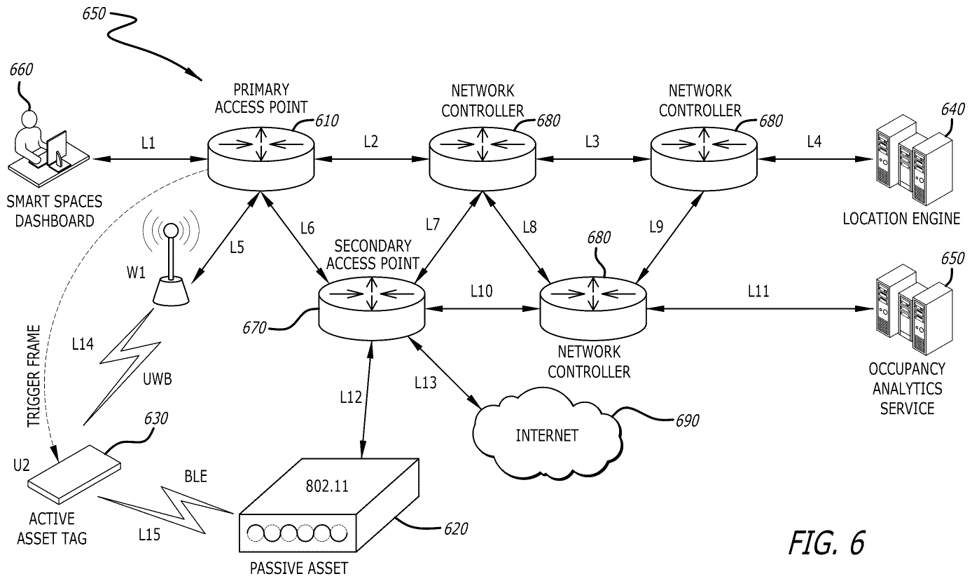

Referring to FIG. 6, a network topology 600 for aggregating occupancy data from active asset tags to a cloud analytics service in accordance with various embodiments of the disclosure is shown. In many embodiments, the network topology 600 illustrates the hierarchical communication structure required to process and analyze environmental sensing data collected from a distributed field of devices. The network topology 600 delineates the separation of duties between edge devices, local network controllers, and remote cloud services to ensure scalability and real-time performance. Furthermore, the network topology 600 provides the necessary pathways for both uplink telemetry data, such as sensor readings and location blinks, and downlink control data, such as firmware updates or configuration profiles.

In various embodiments, the active asset tag 630 serves as a primary sensing node within the physical environment that is capable of performing onboard processing. The active asset tag 630 is configured to transmit multiple types of wireless signals, including ultra-wideband blinks and Bluetooth low energy beacons, which are necessary for multi-modal detection. In some embodiments, the active asset tag 630 utilizes internal logic to filter data before transmission, sending only high-confidence occupancy notifications to conserve network bandwidth. Additionally, the active asset tag 630 maintains a synchronized clock with the network infrastructure to enable precise time-difference-of-arrival calculations for localization and radar sensing.

In a number of embodiments, the passive asset 620 represents a standard tracking tag or an object that interacts with the wireless signals in a passive manner. The passive asset 620 may continuously broadcast simple identification packets without performing any environmental analysis or onboard inference. Despite its lack of active sensing, the passive asset 620 plays a critical role by acting as a known reference point or a reflector for the signals transmitted by the active asset tag 630. The system uses the known position and signal characteristics of the passive asset 620 to calibrate the environment and distinguish between static background clutter and dynamic human movement.

In many embodiments, the primary access point 610 acts as the immediate gateway for the wireless devices located within a specific coverage cell. The primary access point 610 is equipped with the necessary radio interfaces to receive transmissions from both the active asset tag 630 and the passive asset 620. Upon receiving a signal, the primary access point 610 timestamps the arrival of the packet with high precision, which is essential for the radar-based distance measurements. The primary access point 610 then encapsulates this raw signal data, along with signal strength indicators, and forwards it upstream for further processing.

In further embodiments, the secondary access point 670 functions similarly to the primary access point 610 but provides spatial diversity for the received signals. The secondary access point 670 captures the same transmissions from the active asset tag 630 from a different physical angle and distance. By collecting signal data from multiple vantage points, the system can triangulate the position of the transmitting device and resolve multipath ambiguities. The secondary access point 670 ensures that even if the line of sight to the primary access point 610 is obstructed, the system maintains a continuous stream of data for occupancy determination.

In various embodiments, the network controller 680 serves as a local aggregation point that manages a cluster of access points within the facility. The network controller 680 receives the encapsulated telemetry streams from both the primary access point 610 and the secondary access point 670. In some embodiments, the network controller 680 performs initial data filtering or deduplication to reduce the volume of traffic sent over the wide area network. Additionally, the network controller 680 is responsible for managing the radio resource assignments and ensuring that the wireless spectrum is utilized efficiently across the deployment.

In a number of embodiments, the location engine 640 is a specialized server or service responsible for calculating the precise geospatial coordinates of the devices in the network. The location engine 640 processes the timestamp and signal strength data forwarded by the network controller 680 to solve for the x, y, and z coordinates of the active asset tag 630. This coordinate data provides the foundational “ground truth” regarding where the sensors are located in the physical space. The location engine 640 may utilize algorithms such as time-difference-of-arrival or angle-of-arrival to achieve sub-meter accuracy for the tracked assets.

In many embodiments, the occupancy analytics service 650 is a cloud-based platform that ingests the location data and the specific occupancy notifications to generate actionable insights. The occupancy analytics service 650 applies advanced machine learning models to the aggregated data to identify patterns of usage, such as peak occupancy hours or underutilized meeting rooms. This service maintains the historical time-series databases required to train and refine the global detection models. Furthermore, the occupancy analytics service 650 correlates the data from the active asset tag 630 with the structural map of the building to produce heatmaps and utilization reports.

In various embodiments, the smart spaces dashboard 660 provides the user interface for facility managers and network administrators to interact with the system. The smart spaces dashboard 660 visualizes the real-time location of assets and the occupancy status of rooms on an interactive digital map. Users can configure alerts, define zones of interest, and view historical analytics through the smart spaces dashboard 660. Additionally, the smart spaces dashboard 660 allows administrators to push configuration updates or firmware patches to the active asset tag 630 and other edge devices.

In some embodiments, the internet 690 represents the wide area network backbone that connects the local network infrastructure to the remote cloud services. The internet 690 facilitates the secure transmission of encrypted telemetry data from the facility to the external processing centers. This connectivity allows the system to leverage virtually unlimited computing power for complex analytics that would be infeasible to run on local hardware. The internet 690 also enables remote access to the smart spaces dashboard 660 from any location in the world.

As one example embodiment of operation within the network topology 600, the active asset tag 630 may detect a significant variation in its local signal environment indicating the presence of a person. The active asset tag 630 processes this data locally and transmits a succinct occupancy notification message to the primary access point 610. The primary access point 610 forwards this notification through the network controller 680 and across the internet 690 to the occupancy analytics service 650. The occupancy analytics service 650 immediately updates the database for that specific room, triggering an update on the smart spaces dashboard 660 to show the room as “Occupied” in real-time.

In another example embodiment, the system may utilize the network topology 600 to perform a high-precision headcount using ultra-wideband radar. The active asset tag 630 transmits a series of blink signals that are received by both the primary access point 610 and the secondary access point 670. These access points measure the channel impulse response of the signals and forward the raw waveform data to the network controller 680. The network controller 680 bundles this data and streams it to the occupancy analytics service 650, where a complex neural network analyzes the multipath reflections captured by the multiple receivers to estimate the number of people in the room.

In yet another example embodiment, the network topology 600 facilitates the continuous improvement of the detection algorithms through a feedback loop. The occupancy analytics service 650 may analyze data collected over several weeks to identify a recurring false positive pattern caused by a specific type of interference. The service generates an updated set of model weights that accounts for this interference and prepares a firmware update package. This update is sent back through the internet 690, to the network controller 680, and distributed by the primary access point 610 to the active asset tag 630, thereby improving the accuracy of the local inference engine on the device.

Although a specific embodiment for a network topology 600 for carrying out the various steps, processes, methods, and operations described herein is discussed with respect to FIG. 6, any of a variety of systems and/or devices may be utilized in accordance with embodiments of the disclosure. For example, the functions of the location engine 640 and the occupancy analytics service 650 could be combined into a single on-premises server for high-security environments. The elements depicted in FIG. 6 may also be interchangeable with other elements of FIGS. 1-5 and FIGS. 7-16 as required to realize a particularly desired embodiment.

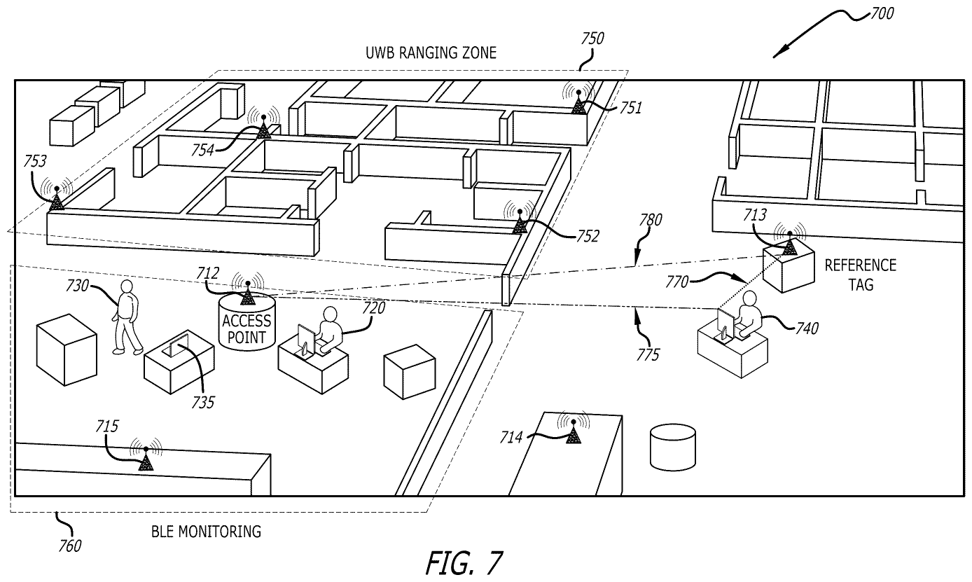

Referring to FIG. 7, a perspective view of a physical environment 700 illustrating bistatic radar vector paths between a reference tag, a target, and a receiver in accordance with various embodiments of the disclosure is shown. In many embodiments, the physical environment 700 represents a complex indoor space, such as a warehouse, office, or hospital floor, that contains both stationary infrastructure and dynamic elements. The physical environment 700 demonstrates the spatial relationships required to perform bistatic or multistatic radar sensing using non-specialized hardware components. Furthermore, the physical environment 700 illustrates how the system can be segmented into different logical areas based on the required fidelity of detection or the specific hardware capabilities available in that section.

In various embodiments, the access point 712 functions as the radar receiver and anchor node for the sensing operations. The access point 712 is typically mounted in a fixed, elevated position to maximize line-of-sight coverage across the monitored area. The access point 712 is configured to receive ultra-wideband pulses and measure the precise time of arrival for each signal. Additionally, the access point 712 serves as the data collection gateway, aggregating signal impulse responses and forwarding them to a central processor for analysis.

In a number of embodiments, the reference tag 713 acts as the radar transmitter or illuminator for the bistatic system. The reference tag 713 is a battery-powered active asset tag that is attached to a stationary object, such as a shelf, wall, or heavy equipment. The reference tag 713 emits periodic blink signals that propagate through the room, illuminating potential targets with radio frequency energy. Because the position of the reference tag 713 is known to the system, it provides a stable origin point for the geometric calculations required to locate reflections.

In many embodiments, the target 740 represents the object or person that the system intends to locate or count. The target 740 is situated within the propagation path of the signals transmitted by the reference tag 713. As the radio waves strike the target 740, they are scattered in multiple directions, creating multipath components that differ from the empty room signature. The target 740 essentially acts as a signal reflector, and its position is derived mathematically rather than through direct communication.

In some embodiments, the first signal path 770 represents the incident signal traveling from the transmitter to the reflector. The first signal path 770 corresponds to the distance between the known location of the reference tag 713 and the unknown location of the target 740. This path describes the initial leg of the radar journey where the energy travels through the air before interacting with the human body. The length of the first signal path 770 is a variable in the non-linear equations used to solve for the target's coordinates.

In additional embodiments, the second signal path 775 represents the reflected signal traveling from the reflector to the receiver. The second signal path 775 corresponds to the distance between the unknown location of the target 740 and the known location of the access point 712. This path captures the echo of the blink signal after it has bounced off the target 740. The system measures the total time of flight, which essentially represents the sum of the traversal times for the first signal path 770 and the second signal path 775.

In further embodiments, the direct path 780 represents the line-of-sight signal traveling directly from the transmitter to the receiver. The direct path 780 establishes the baseline time of arrival because it is the shortest possible distance between the reference tag 713 and the access point 712. The system uses the arrival time of the signal along the direct path 780 to synchronize the clocks or to establish a “zero” point for calculating the additional delay introduced by the reflection. Comparing the reflected path against the direct path 780 allows the system to isolate the specific delay caused by the target 740.

In various embodiments, the static occupant 720 represents a person who is present in the environment but not actively moving around, such as someone sitting at a desk. The static occupant 720 may not generate large doppler shifts or significant changes in received signal strength. However, the static occupant 720 still creates a consistent multipath reflection or “shadow” in the channel impulse response. The system can detect the static occupant 720 by identifying stable but anomalous features in the channel state information compared to a calibrated empty room baseline.

In a number of embodiments, the moving target 730 represents a person who is actively traversing the environment. The moving target 730 introduces dynamic variations into the wireless channel, causing rapid fluctuations in both signal strength and channel impulse response. The system can track the trajectory of the moving target 730 by continuously solving the localization equations as the reflection point shifts over time. Detecting the moving target 730 often requires less sensitivity than detecting a static person due to the pronounced signal variances generated by motion.

In many embodiments, the ultra-wideband ranging zone 750 defines a specific area within the facility where high-precision localization is active. The ultra-wideband ranging zone 750 is characterized by a higher density of sensing nodes or the specific activation of ultra-wideband radios on the tags. In this zone, the system creates a fine-grained grid capable of pinpointing the exact coordinates of occupants. This area might correspond to high-value zones like secure laboratories or crowded conference rooms where exact headcount is necessary.

In some embodiments, the Bluetooth low energy monitoring zone 760 represents an area covered primarily by low-power presence detection. The Bluetooth low energy monitoring zone 760 relies on the broader, less power-intensive beacon signals to detect general occupancy. In this zone, the system may only report whether a person is present or absent, rather than their specific coordinates. This zone allows the system to cover large areas of the facility efficiently without draining the batteries of the asset tags unnecessarily.

In further embodiments, the sensing coverage is expanded by additional stationary nodes, such as a first peripheral reference tag 714 and a second peripheral reference tag 715, which are positioned at the boundaries of the room to increase the diversity of bistatic signal paths and reduce blind spots. Within the specific high-fidelity area defined as the ultra-wideband ranging zone 750, a dense cluster of zone anchors 751, 752, 753, and 754 may be deployed to ensure multi-angle visibility and redundancy for exact coordinate calculations. Additionally, the system can effectively manage the presence of non-human objects. For instance, a mobile asset tag 735 attached to a portable container can continuously report its location to the access point 712, allowing the occupancy logic to dynamically filter out the signal reflections caused by the mobile asset tag 735 so they are not mistaken for the movement of the moving target 730.

As one example of operation within the physical environment 700, the system may initiate a bistatic radar calculation when the reference tag 713 transmits a blink. The access point 712 receives the direct signal via the direct path 780 at time T0. Slightly later, at time T1, the access point 712 receives the reflected signal that traveled along the first signal path 770 and the second signal path 775. By calculating the difference between T1 and T0, and knowing the speed of light, the system determines the total extra distance traveled by the reflected signal. This total distance defines an ellipse with the reference tag 713 and access point 712 as foci, and the target 740 lies somewhere on that ellipse.

In another example, the system utilizes the distinction between the static occupant 720 and the moving target 730 to optimize power consumption. If the system detects the high-variance signatures associated with the moving target 730, it may trigger a burst of high-frequency scans to track the movement path accurately. Once the person sits down and becomes a static occupant 720, the signal variance decreases. In response, the system may transition to a lower sampling rate, relying on the persistence of the multipath reflection in the channel impulse response to confirm that the person is still in the room without needing continuous high-speed updates.

In yet another example, the system manages the transition of a person moving between the Bluetooth low energy monitoring zone 760 and the ultra-wideband ranging zone 750. As a person walks through the Bluetooth low energy monitoring zone 760, the system detects a rough presence based on signal strength attenuation. As the person crosses into the ultra-wideband ranging zone 750, the tags in that area receive a command to activate their ultra-wideband radios. The system then seamlessly switches from simple presence detection to precise coordinate tracking, providing a “zoom-in” effect for the high-value area while maintaining efficiency elsewhere.

Although a specific embodiment for a physical environment 700 for carrying out the various steps, processes, methods, and operations described herein is discussed with respect to FIG. 7, any of a variety of systems and/or devices may be utilized in accordance with embodiments of the disclosure. For example, the reference tag 713 could be replaced by a secondary access point acting as a transmitter. The elements depicted in FIG. 7 may also be interchangeable with other elements of FIGS. 1-6, and 8-16 as required to realize a particularly desired embodiment.

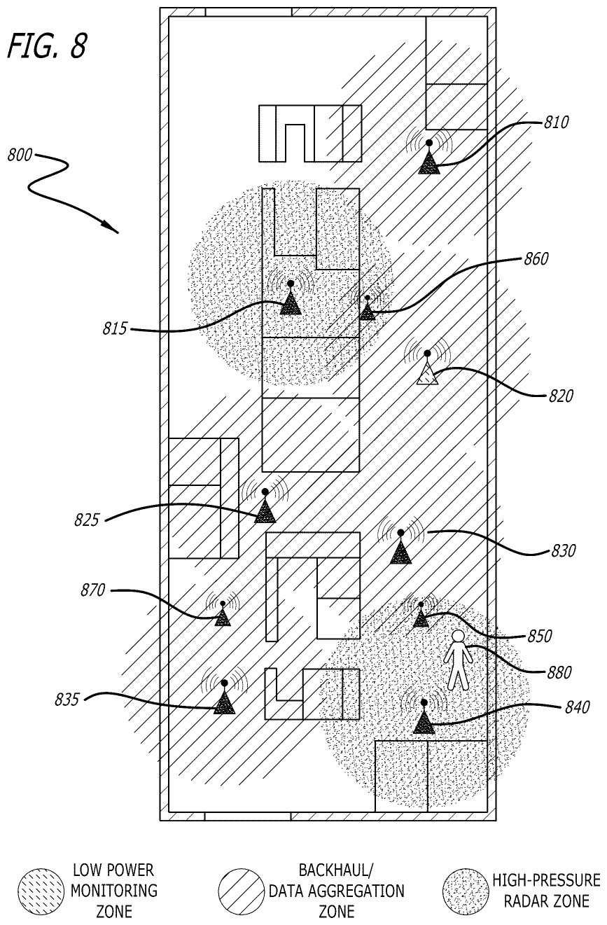

Referring to FIG. 8, a plan view of an environment 800 illustrating different wireless coverage zones for hybrid occupancy monitoring in accordance with various embodiments of the disclosure is shown. In many embodiments, the environment 800 depicts a floor plan of a facility, such as an office building or warehouse, that is segmented into distinct areas based on monitoring requirements. The environment 800 demonstrates how different wireless technologies can be layered to optimize both detection accuracy and system efficiency. Furthermore, the environment 800 illustrates the concept of dynamic triggering, where activity in a low-power zone can activate high-precision sensing in a specific area of interest.

In various embodiments, the multi-modal access point 810 represents a network infrastructure device capable of communicating via multiple wireless protocols simultaneously. The multi-modal access point 810 is strategically placed to provide overlapping coverage for wi-fi, Bluetooth low energy, and ultra-wideband signals. By supporting these diverse radios, the multi-modal access point 810 serves as a unified gateway for both data backhaul and environmental sensing. This consolidation of functions allows the system to switch between sensing modes without requiring separate physical receivers for each technology.

In a number of embodiments, the asset tag 850 functions as a distributed sensing node located within the monitored space. The asset tag 850 is an active device equipped with onboard logic to process environmental signals locally. Depending on its location and the current system state, the asset tag 850 may operate in a low-power beaconing mode or a high-performance ranging mode. The asset tag 850 continuously evaluates the local conditions to determine whether to transmit simple presence data or complex channel impulse response information.

In many embodiments, the low-power monitoring zone 815 defines an area covered primarily by energy-efficient detection methods. The low-power monitoring zone 815 utilizes Bluetooth low energy signals to detect general occupancy presence through signal attenuation or received signal strength indicator variance. This zone is ideal for areas where exact coordinate tracking is unnecessary, such as hallways or large open storage areas. By defaulting to this monitoring mode, the system significantly extends the battery life of the asset tag 850 while still maintaining awareness of activity in the area.

In some embodiments, the high-precision radar zone 840 represents a specific region where fine-grained localization is currently active. The high-precision radar zone 840 employs ultra-wideband ranging to determine the exact position and count of occupants with sub-meter accuracy. This zone may be permanently active for critical areas or dynamically activated based on triggers from the low-power sensors. Within the high-precision radar zone 840, the system can track complex movements and distinguish between multiple targets in close proximity.

In further embodiments, the data aggregation zone 820 illustrates the broader coverage area provided by the wi-fi network for backhauling telemetry. The data aggregation zone 820 ensures that all sensing data collected by the multi-modal access point 810 and the asset tag 850 can be reliably transmitted to the cloud for analysis. This zone typically encompasses the entire facility, providing a pervasive connectivity layer that supports the sensing operations. The robust connectivity in the data aggregation zone 820 is essential for real-time reporting and for receiving model updates from the central server.

In additional embodiments, the triggered sensing area 880 depicts a specific sub-section of the environment where a transition between monitoring modes has occurred. The triggered sensing area 880 activates when the system detects an anomaly or presence in the low-power monitoring zone 815. Upon detection, the system commands the devices in this specific area to switch to high-precision sensing to verify the event. This dynamic allocation of resources allows the triggered sensing area 880 to provide “zoom-in” capabilities only when and where they are needed.

In addition to the primary zones, the environment 800 is populated with a mesh of secondary sensing nodes 825, 830, and 835, which are distributed throughout the data aggregation zone 820 to maintain connectivity and provide baseline environmental data in areas with lower traffic density. These nodes ensure that even peripheral areas remain monitored for unexpected asset movement or unauthorized entry. Furthermore, the system utilizes boundary tags 860 and 870 specifically positioned at the thresholds between the low-power monitoring zone 815 and the high-precision radar zone 840. The boundary tags 860 and 870 act as transition triggers; when a target is detected passing these specific devices, the system anticipates the entry into the triggered sensing area 880 and preemptively wakes the localized high-performance sensors to ensure there is no latency in tracking the occupant.

As one example of operation within the environment 800, a person may enter the low-power monitoring zone 815, causing a fluctuation in the Bluetooth signal received by the multi-modal access point 810. The system identifies this fluctuation as a potential entry event but cannot yet pinpoint the exact location. In response, the system designates the immediate vicinity as a triggered sensing area 880 and sends a wake-up command to the asset tag 850 located nearby. The asset tag 850 then activates its ultra-wideband radio, creating a high-precision radar zone 840 that is temporary to track the person's exact path to a specific desk.

In another example, the environment 800 may be configured to manage power consumption based on the time of day. During business hours, the high-precision radar zone 840 might be active by default in conference rooms to provide accurate headcounts for meeting analytics. However, after hours, these same rooms may revert to being part of the low-power monitoring zone 815. If a security guard walks through at night, the asset tag 850 detects the motion via Bluetooth and only triggers the high-precision radar zone 840 if the movement pattern is classified as suspicious or unrecognized.

In yet another example, the density of the multi-modal access point 810 deployment determines the granularity of the zones. In areas with high asset density, multiple access points may create overlapping coverage, allowing the high-precision radar zone 840 to be extremely precise through multi-static triangulation. Conversely, in the data aggregation zone 820 covering a parking garage, the access points may be spaced further apart, relying almost exclusively on the broader reach of the low-power monitoring zone 815 for simple presence detection.

Although a specific embodiment for an environment 800 for carrying out the various steps, processes, methods, and operations described herein is discussed with respect to FIG. 8, any of a variety of systems and/or devices may be utilized in accordance with embodiments of the disclosure. For example, the coverage zones could be defined by software logic rather than physical radio range. The elements depicted in FIG. 8 may also be interchangeable with other elements of FIGS. 1-7 and FIGS. 9-16 as required to realize a particularly desired embodiment.

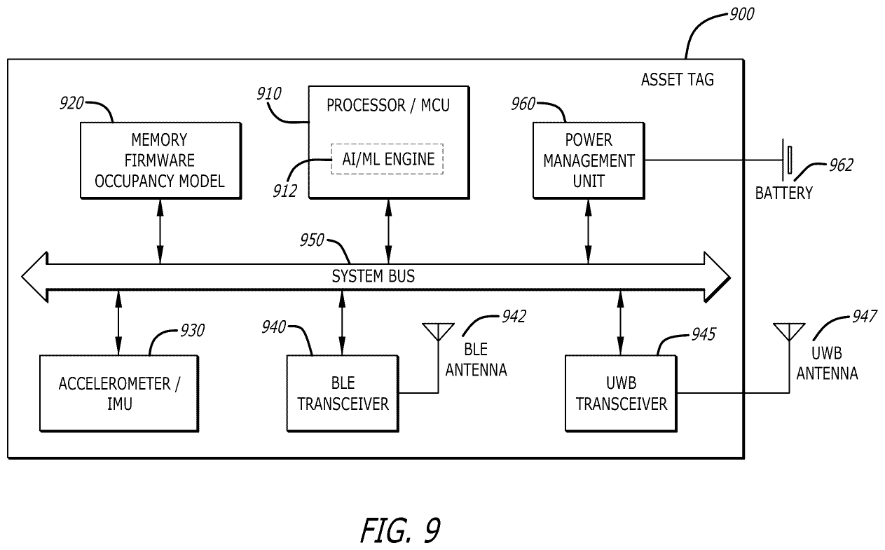

Referring to FIG. 9, a block diagram of an active asset tag 900 configured for multi-modal sensing in accordance with various embodiments of the disclosure is shown. In many embodiments, the active asset tag 900 represents a compact, battery-operated edge device designed to be attached to mobile equipment or fixed infrastructure within a facility. The active asset tag 900 is engineered to perform dual functions of asset tracking and environmental sensing by leveraging its onboard computational and communication capabilities. Furthermore, the active asset tag 900 is designed to operate autonomously for extended periods, making intelligent decisions about when to transmit data to conserve energy.

In various embodiments, the system bus 950 serves as the internal communication backbone that connects the various electronic components within the device. The system bus 950 facilitates the high-speed transfer of data and control signals between the processing units, memory modules, and peripheral transceivers. By providing a shared data path, the system bus 950 allows the processor to efficiently manage the flow of sensor data from the accelerometer to the radio interfaces. Additionally, the system bus 950 supports the synchronization of timing signals across the components, which is critical for accurate timestamping in radar applications.

In a number of embodiments, the processor 910 acts as the central control unit for the active asset tag 900, executing the firmware instructions that govern the device's operation. The processor 910 is typically a low-power microcontroller unit capable of managing the sleep states and wake-up triggers of the peripheral hardware. In some embodiments, the processor 910 coordinates the timing of the wireless transmissions to ensure they align with the network's scheduling requirements. The processor 910 also handles the initial formatting of the telemetry packets before they are handed off to the communication radios.

In many embodiments, the artificial intelligence engine 912 is a specialized logic block or coprocessor dedicated to executing machine learning inference tasks locally on the device. The artificial intelligence engine 912 is optimized to run lightweight classification models, such as decision trees or quantized neural networks, without imposing a heavy power burden. By processing raw sensor data onboard, the artificial intelligence engine 912 enables the active asset tag 900 to determine occupancy states immediately rather than transmitting raw data to the cloud for analysis. This capability allows the device to filter out irrelevant noise and only report significant events, thereby saving bandwidth.

In further embodiments, the memory 920 provides the necessary storage for the device's firmware, configuration profiles, and temporary data buffers. The memory 920 stores the pre-trained occupancy models utilized by the artificial intelligence engine 912 to classify environmental features. Additionally, the memory 920 acts as a circular buffer for capturing time-series data from the sensors, allowing the system to perform windowed analysis on recent signal trends. The memory 920 may also retain identity credentials and security keys required to authenticate the device with the network infrastructure.

In additional embodiments, the accelerometer 930 is an inertial measurement unit that continuously monitors the physical movement of the active asset tag 900. The accelerometer 930 generates motion data that allows the system to distinguish whether the tag itself is moving or if it is stationary. This distinction is vital for the occupancy detection logic, as the system must know if signal variations are caused by the tag moving through space or by external objects moving around the tag. The accelerometer 930 can also serve as a wake-up trigger, bringing the processor 910 out of a deep sleep mode only when physical motion is detected.

In various embodiments, the Bluetooth low energy transceiver 940 is a radio interface designed for low-power, short-range communication. The Bluetooth low energy transceiver 940 is responsible for broadcasting the periodic beacon signals used for presence detection and coarse localization. In some embodiments, the Bluetooth low energy transceiver 940 also scans for advertisements from other nearby tags, enabling peer-to-peer sensing or proximity detection. This radio is typically the default communication channel due to its energy efficiency, maintaining a baseline link with the access points.

In a number of embodiments, the Bluetooth low energy antenna 942 converts the electrical signals from the transceiver into electromagnetic waves for transmission. The Bluetooth low energy antenna 942 is tuned to the specific frequency bands used by the Bluetooth protocol to maximize signal propagation. The physical design of the Bluetooth low energy antenna 942 may be omnidirectional to ensure that beacon signals are received by access points regardless of the tag's orientation. Proper tuning of the Bluetooth low energy antenna 942 is essential for maintaining consistent signal strength readings, which are used as a primary metric for occupancy sensing.

In many embodiments, the ultra-wideband transceiver 945 is a high-precision radio interface capable of measuring time-of-flight with sub-nanosecond accuracy. The ultra-wideband transceiver 945 transmits the blink signals that are used for both fine-grained asset tracking and bistatic radar sensing. Unlike the Bluetooth radio, the ultra-wideband transceiver 945 may be activated only when specific trigger conditions are met, such as when high-precision localization is required. This transceiver captures the complex channel impulse response data that reveals the multipath reflections in the environment.

In some embodiments, the ultra-wideband antenna 947 is specifically designed to handle the broad frequency spectrum utilized by ultra-wideband pulse signals. The ultra-wideband antenna 947 ensures that the short-duration pulses retain their shape and timing integrity as they propagate through the air. Minimizing distortion at the ultra-wideband antenna 947 is critical because the radar sensing algorithms rely on the precise shape and arrival time of the signal peaks. The ultra-wideband antenna 947 enables the system to resolve fine spatial details that would be lost with narrower band antennas.

In further embodiments, the power management unit 960 regulates the distribution of electrical power to the various components of the active asset tag 900. The power management unit 960 intelligently gates power to subsystems that are not in use, such as turning off the ultra-wideband transceiver 945 during idle periods. Additionally, the power management unit 960 monitors the remaining charge of the power source and can trigger a low-power mode if the energy reserves fall below a critical threshold. This active management ensures that the device meets its multi-year operational life expectancy.

In various embodiments, the battery 962 serves as the independent power source for the active asset tag 900, enabling it to operate without wired connections. The battery 962 is typically a coin cell or similar compact energy storage medium that provides a stable voltage for the electronics. The capacity of the battery 962 is a primary constraint for the system design, influencing the adaptive sampling rates and transmission intervals. The system relies on the efficient use of the battery 962 to minimize maintenance cycles associated with replacing or recharging tags in a large deployment.

As one example of operation for the active asset tag 900, the accelerometer 930 detects that the device is stationary. The processor 910 instructs the artificial intelligence engine 912 to enter an occupancy sensing mode. The processor 910 then commands the Bluetooth low energy transceiver 940 to sample the received signal strength from nearby devices. This data is fed into the artificial intelligence engine 912, which uses the model stored in the memory 920 to determine if the signal variance indicates a person is nearby. If occupancy is detected, the processor 910 wakes the ultra-wideband transceiver 945 to send a high-precision blink for confirmation.

In another example, the active asset tag 900 may receive a firmware update via the Bluetooth low energy antenna 942. The Bluetooth low energy transceiver 940 passes the update packet through the system bus 950 to be written into the memory 920. This update might contain a refined neural network model for the artificial intelligence engine 912, improving its ability to distinguish between human movement and mechanical interference. The power management unit 960 ensures that the processor 910 has sufficient voltage to complete the write operation without corruption.

In yet another example, the power management unit 960 detects that the battery 962 is nearing the end of its life. It signals the processor 910 to switch the device into a “beacon-only” mode. The processor 910 disables the ultra-wideband transceiver 945 that is power-hungry and the artificial intelligence engine 912. The device continues to operate using only the Bluetooth low energy transceiver 940 to transmit basic identity packets, ensuring that the asset can still be located even though the advanced environmental sensing features are temporarily suspended to preserve the remaining charge.

Although a specific embodiment for an active asset tag 900 for carrying out the various steps, processes, methods, and operations described herein is discussed with respect to FIG. 9, any of a variety of systems and/or devices may be utilized in accordance with embodiments of the disclosure. For example, the processor 910 and artificial intelligence engine 912 may be integrated into a single system-on-chip. The elements depicted in FIG. 9 may also be interchangeable with other elements of FIGS. 1-8 and FIGS. 10-16 as required to realize a particularly desired embodiment.

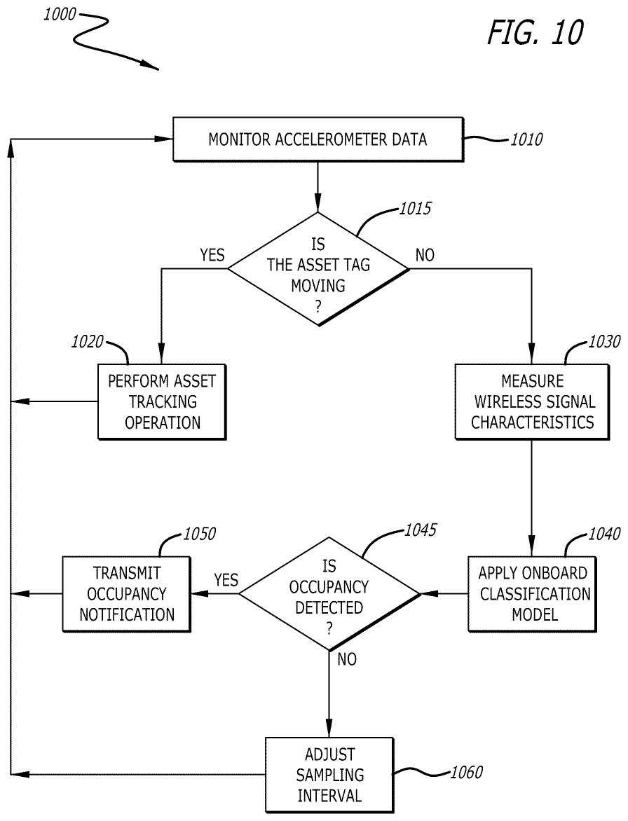

Referring to FIG. 10, a flowchart depicting a process 1000 for determining an occupancy state on an asset tag based on motion awareness in accordance with various embodiments of the disclosure is shown. In many embodiments, the process 1000 can be executed by a processor or a dedicated artificial intelligence engine located directly on the asset tag. The process 1000 enables the asset tag to function autonomously, switching between roles based on its physical state to optimize battery life and network utility. By processing data locally, the process 1000 reduces the bandwidth required for continuous environmental monitoring.

In many embodiments, the process 1000 can monitor accelerometer data (block 1010). The process 1000 may continuously sample readings from an onboard inertial measurement unit to detect vibrations, orientation changes, or physical displacement. For example, the asset tag might be attached to a piece of mobile medical equipment, and the accelerometer detects the specific vibration frequencies associated with the equipment being pushed down a hallway. Alternatively, the process 1000 might utilize a low-power wake-up circuit that only activates the main processor when a significant g-force threshold is exceeded, ensuring that the device remains in a deep sleep mode during periods of total inactivity. In some configurations, the accelerometer data is buffered for a short duration to analyze the pattern of movement rather than just the instantaneous magnitude.

In further embodiments, the process 1000 can determine if the asset tag is moving (block 1015). If it is determined that the asset tag is moving, then the process 1000 can perform an asset tracking operation (block 1020). However, if it is determined that the asset tag is not moving, then the process 1000 can measure wireless signal characteristics (block 1030). This decision logic ensures that the system separates self-motion from environmental motion, as signal variances caused by the tag moving through space could otherwise be misinterpreted as external occupancy. For instance, if the tag is in motion, the variations in received signal strength are likely due to the changing distance to the access point rather than a person moving nearby.

In some embodiments, the process 1000 can perform an asset tracking operation (block 1020). This operation may involve transmitting a rapid sequence of ultra-wideband blinks to allow the network infrastructure to triangulate the changing position of the asset tag. For instance, if a wheelchair is being moved, the process 1000 switches to a high-frequency update rate to provide real-time location visibility on a facility dashboard. In other embodiments, the process 1000 may simply log the movement start time and end time to calculate utilization metrics without performing full triangulation. After performing the tracking operation, the process 1000 typically loops back to monitoring the accelerometer to determine when the motion has ceased.

In additional embodiments, the process 1000 can measure wireless signal characteristics (block 1030). The process 1000 may passively scan for Bluetooth low energy advertisement packets from nearby beacons and record their received signal strength indicator values. For example, the tag might measure the signal strength from a fixed access point every one-hundred milliseconds to detect attenuation caused by a person walking between the devices. Alternatively, the process 1000 might transmit a channel sounding packet and record the channel state information reflecting the multipath environment. In certain embodiments, the process 1000 adjusts the gain or sensitivity of the wireless transceiver to ensure the measurements are within a linear range for analysis.

In yet further embodiments, the process 1000 can apply an onboard classification model (block 1040). The process 1000 may feed the collected signal characteristics into a machine learning model, such as a decision tree or a quantized neural network, running on the microcontroller of the asset tag. For instance, the model might analyze the statistical variance of the signal strength over a fixed time window to distinguish between static interference and human motion. In some embodiments, the onboard classification model is trained to recognize specific signatures, such as the rhythmic signal blocking caused by breathing or walking. The application of this model locally allows the device to filter out noise and irrelevant data before it consumes transmission power.

In still more embodiments, the process 1000 can determine if occupancy is detected (block 1045). If it is determined that occupancy is detected, then the process 1000 can transmit an occupancy notification (block 1050). However, if it is determined that occupancy is not detected, then the process 1000 can adjust a sampling interval (block 1060). This binary determination converts complex raw data into a simple state, significantly reducing the amount of data that needs to be sent over the wireless network. The threshold for detection can be dynamically adjusted based on the time of day or the specific sensitivity requirements of the monitored zone.

In various embodiments, the process 1000 can transmit an occupancy notification (block 1050). The process 1000 may send a small, low-latency packet via Bluetooth low energy to the nearest access point indicating that the room is occupied. For example, the notification might effectively be a single bit flag in a heartbeat packet, minimizing power consumption while providing near real-time status. In other embodiments, the transmission includes metadata about the detection confidence level or the specific type of motion detected, such as a “high activity” or “sedentary” classification. Once the notification is sent, the process 1000 typically returns to monitoring to detect if the occupancy state changes.

In a number of embodiments, the process 1000 can adjust a sampling interval (block 1060). If no occupancy is detected for a prolonged period, the process 1000 may decrease the frequency of signal measurements to conserve the battery life of the asset tag. For instance, the sampling rate might drop from 10 Hz to 1 Hz after ten minutes of silence in the signal environment. Conversely, if the system is in a high-alert mode, the process 1000 may maintain a high sampling rate even when the room appears empty to ensure rapid detection of any new entry. This adaptive behavior ensures that the device allocates its energy resources efficiently based on the current context of the environment.

Although a specific embodiment for a process 1000 for determining an occupancy state on an asset tag based on motion awareness suitable for carrying out the various steps, processes, methods, and operations described herein is discussed with respect to FIG. 10, any of a variety of systems and/or processes may be utilized in accordance with embodiments of the disclosure. For example, the process 1000 can conduct the motion check in response to an interrupt from the accelerometer rather than polling. The elements depicted in FIG. 10 may also be interchangeable with other elements of FIGS. 1-9 and FIGS. 11-16 as required to realize a particularly desired embodiment.

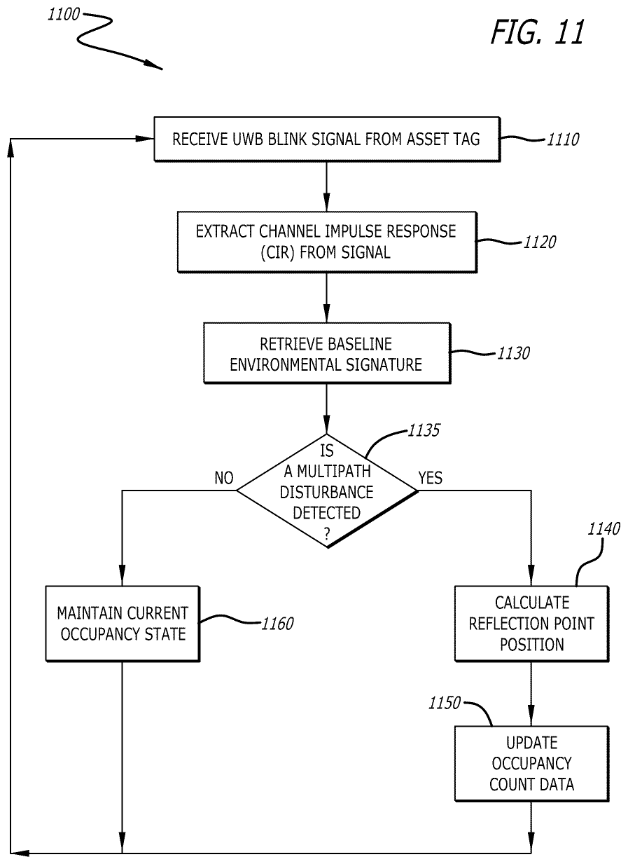

Referring to FIG. 11, a flowchart depicting a process 1100 for detecting occupancy using ultra-wideband radar signals in accordance with various embodiments of the disclosure is shown. In many embodiments, the process 1100 can be executed by a network device, such as an access point or a centralized controller, that processes raw physical layer data. The process 1100 enables the system to utilize standard communication signals as environmental probes, effectively turning a communication network into a radar sensing grid. By analyzing the fine-grained channel information, the process 1100 can distinguish between the direct line-of-sight signal and the complex reflections caused by objects in the room.

In many embodiments, the process 1100 can receive an ultra-wideband blink signal from an asset tag (block 1110). The process 1100 monitors the wireless spectrum for the specific preamble sequences associated with the ultra-wideband physical layer. For example, the asset tag may transmit a scheduled blink every five hundred milliseconds containing its unique identifier and a payload of telemetry data. In some embodiments, the process 1100 receives these signals via multiple antennas simultaneously, allowing for the collection of spatial diversity data from the single transmission event. The reception of this signal serves as the triggering event that initiates the radar processing pipeline for that specific timestamp.

In various embodiments, the process 1100 can extract a channel impulse response from the signal (block 1120). The process 1100 utilizes the known training sequence within the packet header to estimate the channel state information, resulting in a time-domain profile of the signal energy. For instance, the hardware of the receiving device may output a complex vector representing the amplitude and phase of the received signal at various time lags. In some embodiments, the process 1100 normalizes this channel impulse response to account for automatic gain control adjustments applied by the radio receiver. This extraction isolates the multipath components, separating the strong direct path from the weaker scattered paths.

In some embodiments, the process 1100 can retrieve a baseline environmental signature (block 1130). The process 1100 accesses a stored profile that represents the channel characteristics of the environment when it is known to be empty or static. For example, this baseline might be a rolling average of the last one hundred channel impulse responses collected during night hours when no employees were present. In other embodiments, the baseline environmental signature is calibrated manually during the system installation phase. Retrieving this clean signature allows the system to perform a differential analysis, effectively subtracting the static background clutter from the current observation.

In further embodiments, the process 1100 can determine if a multipath disturbance is detected (block 1135). The process 1100 compares the currently extracted channel impulse response against the retrieved baseline to identify statistically significant deviations. If it is determined that no multipath disturbance is detected, meaning the current signal closely matches the empty room profile, then the process 1100 can maintain the current occupancy state (block 1160). However, if it is determined that a multipath disturbance is detected, such as the appearance of a new reflection peak or a shift in phase variance, then the process 1100 can calculate a reflection point position (block 1140). This decision block functions as a gatekeeper to prevent the execution of computationally expensive localization algorithms on clean signals.

In additional embodiments, the process 1100 can calculate a reflection point position (block 1140). The process 1100 utilizes the time delay of the detected multipath peak relative to the direct path to define a bistatic ellipse on which the target must lie. For example, if the reflection arrives ten nanoseconds after the direct path, the process 1100 calculates the corresponding path length difference to estimate the distance of the reflector. In some embodiments, the process 1100 combines these calculations from multiple receivers to find the intersection point of multiple ellipses, thereby pinpointing the target's coordinates. This geometric solution provides the physical location of the person or object that caused the disturbance.

In continuous embodiments, the process 1100 can update an occupancy count data (block 1150). The process 1100 integrates the calculated reflection points into a dynamic map of the environment, incrementing the count of detected occupants for the specific zone. For instance, the process 1100 may utilize a clustering algorithm to group nearby reflection points into a single human target to avoid double counting. In other embodiments, the process 1100 feeds this position data into a tracking filter, such as a Kalman filter, to smooth the trajectory of the target over time. After updating the data, the process 1100 typically returns to the listening state to await the next signal transmission.

In alternative embodiments, the process 1100 can maintain a current occupancy state (block 1160). If the signal analysis reveals no new disturbances, the process 1100 reinforces the previous conclusion that the zone is empty or unchanged. For example, the process 1100 might log a “heartbeat” entry in the database confirming that the system is operational but detecting no activity. This step prevents the system from generating false negatives due to packet loss, as it explicitly affirms the absence of targets based on valid signal reception. The process 1100 then loops back to receive the next blink signal, ensuring continuous monitoring of the environment.

Although a specific embodiment for a process 1100 for detecting occupancy using ultra-wideband radar signals suitable for carrying out the various steps, processes, methods, and operations described herein is discussed with respect to FIG. 11, any of a variety of systems and/or processes may be utilized in accordance with embodiments of the disclosure. For example, the process 1100 can be adapted to utilize channel state information from Wi-Fi signals instead of ultra-wideband blinks. The elements depicted in FIG. 11 may also be interchangeable with other elements of FIGS. 1-10 and FIGS. 12-16 as required to realize a particularly desired embodiment.

Referring to FIG. 11, a flowchart depicting a process 1100 for detecting occupancy using ultra-wideband radar signals in accordance with various embodiments of the disclosure is shown. In many embodiments, the process 1100 can be executed by a network device, such as an access point or a centralized controller, that processes raw physical layer data. The process 1100 enables the system to utilize standard communication signals as environmental probes, effectively turning a communication network into a radar sensing grid. By analyzing the fine-grained channel information, the process 1100 can distinguish between the direct line-of-sight signal and the complex reflections caused by objects in the room.

In many embodiments, the process 1100 can receive an ultra-wideband blink signal from an asset tag (block 1110). The process 1100 monitors the wireless spectrum for the specific preamble sequences associated with the ultra-wideband physical layer. For example, the asset tag may transmit a scheduled blink every five hundred milliseconds containing its unique identifier and a payload of telemetry data. In some embodiments, the process 1100 receives these signals via multiple antennas simultaneously, allowing for the collection of spatial diversity data from the single transmission event. The reception of this signal serves as the triggering event that initiates the radar processing pipeline for that specific timestamp.

In various embodiments, the process 1100 can extract a channel impulse response from the signal (block 1120). The process 1100 utilizes the known training sequence within the packet header to estimate the channel state information, resulting in a time-domain profile of the signal energy. For instance, the hardware of the receiving device may output a complex vector representing the amplitude and phase of the received signal at various time lags. In some embodiments, the process 1100 normalizes this channel impulse response to account for automatic gain control adjustments applied by the radio receiver. This extraction isolates the multipath components, separating the strong direct path from the weaker scattered paths.

In some embodiments, the process 1100 can retrieve a baseline environmental signature (block 1130). The process 1100 accesses a stored profile that represents the channel characteristics of the environment when it is known to be empty or static. For example, this baseline might be a rolling average of the last one hundred channel impulse responses collected during night hours when no employees were present. In other embodiments, the baseline environmental signature is calibrated manually during the system installation phase. Retrieving this clean signature allows the system to perform a differential analysis, effectively subtracting the static background clutter from the current observation.

In further embodiments, the process 1100 can determine if a multipath disturbance is detected (block 1135). The process 1100 compares the currently extracted channel impulse response against the retrieved baseline to identify statistically significant deviations. If it is determined that no multipath disturbance is detected, meaning the current signal closely matches the empty room profile, then the process 1100 can maintain the current occupancy state (block 1160). However, if it is determined that a multipath disturbance is detected, such as the appearance of a new reflection peak or a shift in phase variance, then the process 1100 can calculate a reflection point position (block 1140). This decision block functions as a gatekeeper to prevent the execution of computationally expensive localization algorithms on clean signals.

In additional embodiments, the process 1100 can calculate a reflection point position (block 1140). The process 1100 utilizes the time delay of the detected multipath peak relative to the direct path to define a bistatic ellipse on which the target must lie. For example, if the reflection arrives ten nanoseconds after the direct path, the process 1100 calculates the corresponding path length difference to estimate the distance of the reflector. In some embodiments, the process 1100 combines these calculations from multiple receivers to find the intersection point of multiple ellipses, thereby pinpointing the target's coordinates. This geometric solution provides the physical location of the person or object that caused the disturbance.

In continuous embodiments, the process 1100 can update an occupancy count data (block 1150). The process 1100 integrates the calculated reflection points into a dynamic map of the environment, incrementing the count of detected occupants for the specific zone. For instance, the process 1100 may utilize a clustering algorithm to group nearby reflection points into a single human target to avoid double counting. In other embodiments, the process 1100 feeds this position data into a tracking filter, such as a Kalman filter, to smooth the trajectory of the target over time. After updating the data, the process 1100 typically returns to the listening state to await the next signal transmission.

In alternative embodiments, the process 1100 can maintain a current occupancy state (block 1160). If the signal analysis reveals no new disturbances, the process 1100 reinforces the previous conclusion that the zone is empty or unchanged. For example, the process 1100 might log a “heartbeat” entry in the database confirming that the system is operational but detecting no activity. This step prevents the system from generating false negatives due to packet loss, as it explicitly affirms the absence of targets based on valid signal reception. The process 1100 then loops back to receive the next blink signal, ensuring continuous monitoring of the environment.

Although a specific embodiment for a process 1100 for detecting occupancy using ultra-wideband radar signals suitable for carrying out the various steps, processes, methods, and operations described herein is discussed with respect to FIG. 11, any of a variety of systems and/or processes may be utilized in accordance with embodiments of the disclosure. For example, the process 1100 can be adapted to utilize channel state information from Wi-Fi signals instead of ultra-wideband blinks. The elements depicted in FIG. 11 may also be interchangeable with other elements of FIGS. 1-10 and FIGS. 12-16 as required to realize a particularly desired embodiment.

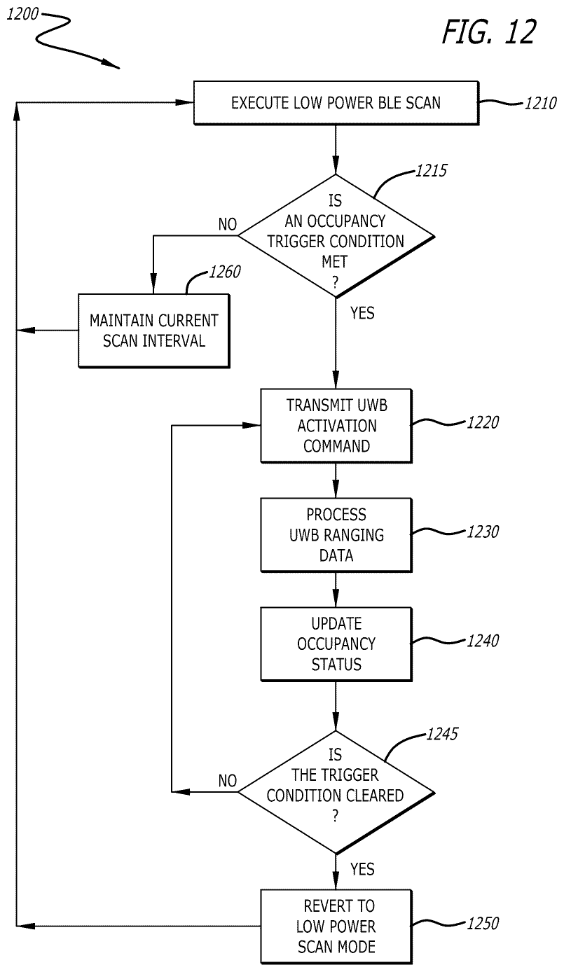

Referring to FIG. 12, a flowchart depicting a process 1200 for triggering high-precision ranging based on low-power monitoring in accordance with various embodiments of the disclosure is shown. In many embodiments, the process 1200 can be executed by a central network controller or an intelligent access point that manages the sensing resources of a connected environment. The process 1200 illustrates a hybrid sensing strategy that balances the need for high-fidelity data with the constraints of battery-operated devices. By defaulting to a passive monitoring state and only escalating to active ranging when necessary, the process 1200 maximizes the operational lifespan of the deployment.

In many embodiments, the process 1200 can execute a low power Bluetooth low energy scan (block 1210). The process 1200 may continuously listen for advertisement packets or beacon frames broadcast by asset tags in the vicinity without initiating a connection. For example, the system might sample the received signal strength indicator of the beacons at a slow interval, such as once every second, to establish a baseline of RF activity. In some embodiments, this scanning is performed using a background process on the access point that does not interfere with standard data traffic. This low-power state allows the system to maintain situational awareness of the environment while minimizing the computational load on the infrastructure.

In further embodiments, the process 1200 can determine if an occupancy trigger condition is met (block 1215). The process 1200 evaluates the data collected during the scan to identify anomalies that suggest human presence, such as a sudden drop in signal strength due to shadowing. If it is determined that an occupancy trigger condition is not met, meaning the environment appears static or empty, then the process 1200 can maintain a current scan interval (block 1260). However, if it is determined that an occupancy trigger condition is met, such as a variance threshold being exceeded, then the process 1200 can transmit an ultra-wideband activation command (block 1220). This decision step acts as a filter, preventing the system from engaging power-hungry resources for insignificant events.

In some embodiments, the process 1200 can transmit an ultra-wideband activation command (block 1220). The process 1200 sends a downlink control message to the specific asset tag identified in the trigger zone, instructing it to wake up its secondary radio. For instance, the command might instruct the tag to begin transmitting ranging blinks at a frequency of ten hertz for the next minute. In other embodiments, the activation command is broadcast to a group of tags in a zone to create a multi-static sensing grid. This targeted activation ensures that high-precision ranging is only performed in the specific spatial sector where activity was detected.

In additional embodiments, the process 1200 can process ultra-wideband ranging data (block 1230). The process 1200 receives the high-fidelity pulses from the activated tag and performs time-difference-of-arrival or channel impulse response analysis. For example, the system might calculate the precise coordinates of a moving target based on the multipath reflections captured by the access points. In some embodiments, the process 1200 aggregates ranging data from multiple neighboring nodes to resolve complex occlusion scenarios. This step provides the detailed spatial resolution that the low-power Bluetooth scan could not achieve on its own.

In yet further embodiments, the process 1200 can update an occupancy status (block 1240). The process 1200 records the confirmed presence and location of the target in the active session database. For instance, the system might update a digital twin of the building to show that “Conference Room B” is now occupied by three people. In some embodiments, this update triggers secondary automation events, such as turning on the lights or adjusting the thermostat for the occupied zone. The update creates a verifiable record of utilization that is supported by the precision of the radar data.

In still more embodiments, the process 1200 can determine if the trigger condition is cleared (block 1245). The process 1200 continuously evaluates whether the factors that initiated the high-precision mode are still present. If it is determined that the trigger condition is not cleared, meaning the target is still moving or present, then the process 1200 can once again transmit an ultra-wideband activation command (block 1220) to maintain the ranging session. However, if it is determined that the trigger condition is cleared, such as the signal variance returning to baseline levels, then the process 1200 can revert to a low power scan mode (block 1250). This check prevents the system from getting stuck in a high-power state unnecessarily.

In various embodiments, the process 1200 can revert to a low power scan mode (block 1250). The process 1200 sends a termination signal to the asset tag, allowing it to power down its ultra-wideband radio and return to a sleep state. For example, the system might explicitly acknowledge that the tracking session is complete and that no further blinks are required. In other embodiments, the tag is configured to auto-revert after a set duration if no keep-alive command is received. This reversion completes the cycle, returning the system to its baseline monitoring state to await the next event.

In a number of embodiments, the process 1200 can maintain a current scan interval (block 1260). The process 1200 continues the background monitoring loop without altering the behavior of the edge devices. For instance, the system maintains the one-second scan interval, logging the heartbeat signals from the tags to confirm connectivity. In some embodiments, the process 1200 performs minor housekeeping tasks during this phase, such as calibrating the baseline noise floor. This state represents the default operating mode for the majority of the system's lifecycle.

Although a specific embodiment for a process 1200 for triggering high-precision ranging based on low-power monitoring suitable for carrying out the various steps, processes, methods, and operations described herein is discussed with respect to FIG. 12, any of a variety of systems and/or processes may be utilized in accordance with embodiments of the disclosure. For example, the trigger condition could be based on a schedule rather than sensor data. The elements depicted in FIG. 12 may also be interchangeable with other elements of FIGS. 1-11 and 13-16 as required to realize a particularly desired embodiment.

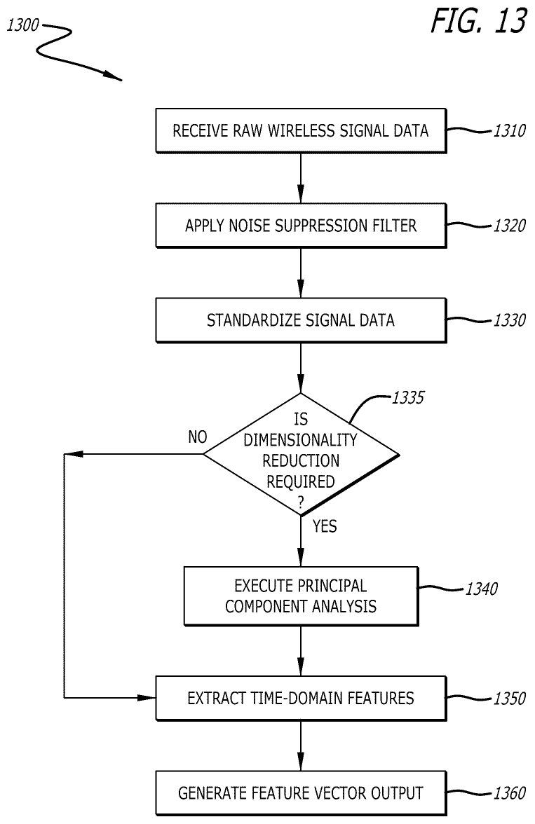

Referring to FIG. 13, a flowchart depicting a process 1300 for signal preprocessing and feature extraction in accordance with various embodiments of the disclosure is shown. In many embodiments, the process 1300 acts as a data preparation pipeline that transforms raw radio frequency measurements into structured inputs suitable for machine learning analysis. The process 1300 ensures that the data fed into the classification models is clean, consistent, and mathematically manageable. By standardizing the inputs, the process 1300 improves the accuracy and convergence speed of the downstream inference engines.

In many embodiments, the process 1300 can receive raw wireless signal data (block 1310). The process 1300 typically ingests a stream of complex numbers representing the channel impulse response or integer values representing the received signal strength indicator. For example, the system may buffer one second worth of channel state information packets arriving from an ultra-wideband radio interface. In some embodiments, the process 1300 receives this data directly from the hardware registers of the wireless transceiver. In other embodiments, the data is retrieved from a circular memory buffer where it was temporarily stored by a direct memory access controller.

In various embodiments, the process 1300 can apply a noise suppression filter (block 1320). The process 1300 may utilize a digital signal processing algorithm to remove high-frequency jitter or thermal noise from the signal. For instance, the process 1300 might pass the raw data through a moving average filter to smooth out instantaneous spikes that do not represent physical movement. In alternative embodiments, the process 1300 applies a bandpass filter to isolate the specific frequency components associated with human respiration or gait. This filtering step is crucial for preventing random environmental noise from generating false positive detections.

In a number of embodiments, the process 1300 can standardize signal data (block 1330). The process 1300 scales the filtered data to a common range, such as between zero and one, or normalizes it to have a mean of zero and unit variance. For example, signal strength readings, which can vary widely based on the distance to the transmitter, may be converted into Z-scores to focus on relative changes rather than absolute magnitude. In some embodiments, the process 1300 applies logarithmic scaling to compress the dynamic range of the signal amplitudes. This standardization ensures that the machine learning model is not biased by the scale of the input features.

In further embodiments, the process 1300 can determine if dimensionality reduction is required (block 1335). The process 1300 checks the configuration profile or the size of the input dataset to decide if the feature space is too large for efficient processing. If it is determined that dimensionality reduction is not required, meaning the dataset is manageable or the model expects raw inputs, then the process 1300 can extract time-domain features (block 1350). However, if it is determined that dimensionality reduction is required, such as when dealing with high-dimensional channel impulse response vectors, then the process 1300 can execute principal component analysis (block 1340). This decision point allows the system to adapt its processing load based on the complexity of the available data.

In additional embodiments, the process 1300 can execute principal component analysis (block 1340). The process 1300 mathematically projects the high-dimensional data onto a lower-dimensional subspace that preserves the maximum variance. For instance, a channel impulse response vector containing one hundred distinct tap values might be compressed into just the top five principal components. In alternative embodiments, the process 1300 might utilize other reduction techniques such as t-distributed stochastic neighbor embedding or simple feature selection. This reduction significantly decreases the computational power required for the subsequent classification steps without discarding critical information.

In some embodiments, the process 1300 can extract time-domain features (block 1350). The process 1300 calculates statistical metrics from the processed signal window, such as the mean, variance, skewness, and kurtosis. For example, a high variance in the signal amplitude over time is often a strong indicator of motion in the environment. In other embodiments, the process 1300 calculates the zero-crossing rate or the peak-to-peak amplitude of the signal waveform. These extracted features serve as the distinct fingerprints that the artificial intelligence model will use to distinguish between an empty room and an occupied one.

In yet further embodiments, the process 1300 can generate a feature vector output (block 1360). The process 1300 aggregates the selected features or principal components into a single, formatted data structure. For example, the output might be a one-dimensional array containing the normalized variance, the peak signal strength, and the first three principal components. In some embodiments, this vector is serialized into a specific format, such as a JSON object or a binary tensor, ready for ingestion by the neural network. Once the feature vector output is generated, the preprocessing phase is complete, and the data is handed off to the inference engine.

Although a specific embodiment for a process 1300 for signal preprocessing and feature extraction suitable for carrying out the various steps, processes, methods, and operations described herein is discussed with respect to FIG. 13, any of a variety of systems and/or processes may be utilized in accordance with embodiments of the disclosure. For example, the process 1300 can be performed entirely in the cloud rather than on the edge device. The elements depicted in FIG. 13 may also be interchangeable with other elements of FIGS. 1-12 and 14-16 as required to realize a particularly desired embodiment.

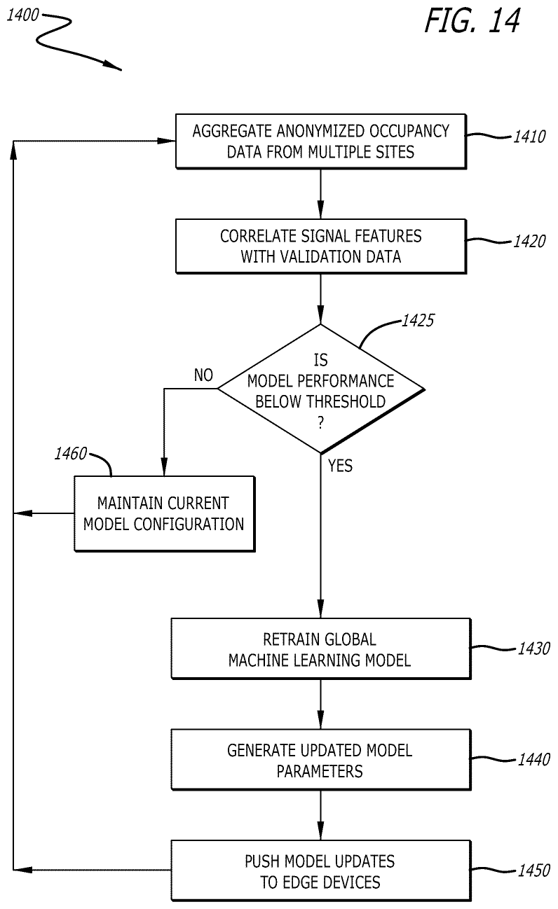

Referring to FIG. 14, a flowchart depicting a process 1400 for model training and updates in accordance with various embodiments of the disclosure is shown. In many embodiments, the process 1400 operates as a continuous improvement loop that runs on a central cloud platform or a dedicated training server. The process 1400 leverages the collective intelligence of the distributed sensor network to refine the detection algorithms over time. By centralizing the learning process, the process 1400 ensures that insights gained from one deployment site can be beneficially applied to other sites with similar environmental characteristics.

In many embodiments, the process 1400 can aggregate anonymized occupancy data from multiple sites (block 1410). The process 1400 collects telemetry streams, feature vectors, and occupancy logs from various tenants or facility locations connected to the cloud service. For example, the system might ingest data from an office building in New York and a hospital in London simultaneously. In some embodiments, the process 1400 strictly scrubs any personally identifiable information from these datasets before ingestion to ensure compliance with privacy regulations. This aggregation creates a diverse and robust training dataset that covers a wide range of physical layouts and interference patterns.

In various embodiments, the process 1400 can correlate signal features with validation data (block 1420). The process 1400 compares the received feature vectors against known ground truth data to evaluate the current accuracy of the system. For instance, the validation data might come from manual occupancy logs, badge swipe records, or feedback provided by users via a mobile application. In some embodiments, the process 1400 calculates specific performance metrics, such as the F1-score, precision, and recall, for the model currently deployed in the field. This correlation step identifies discrepancies where the model's predictions failed to match the actual state of the environment.

In a number of embodiments, the process 1400 can determine if model performance is below threshold (block 1425). The process 1400 checks if the calculated accuracy metrics have fallen below a pre-defined quality standard, such as ninety-five percent accuracy. If it is determined that model performance is not below threshold, meaning the model is functioning adequately, then the process 1400 can maintain current model configuration (block 1460). However, if it is determined that model performance is below threshold, indicating that the model has drifted or is struggling with new edge cases, then the process 1400 can retrain global machine learning model (block 1430). This automated gatekeeping ensures that the system only expends resources on retraining when there is a demonstrable need for improvement.

In some embodiments, the process 1400 can retrain global machine learning model (block 1430). The process 1400 initiates a training session using the newly aggregated dataset to adjust the weights and biases of the neural network. For example, the process 1400 might perform transfer learning, where the existing model is fine-tuned with the recent error cases to correct specific behaviors. In other embodiments, the process 1400 executes a full training run from scratch using a high-performance computing cluster to generate a completely new model architecture. This retraining phase incorporates the latest environmental variations into the core intelligence of the system.

In further embodiments, the process 1400 can generate updated model parameters (block 1440). The process 1400 extracts the final weights from the retrained model and formats them for deployment to the edge devices. For instance, the process 1400 might apply quantization techniques to reduce the precision of the parameters from floating-point to eight-bit integers, reducing the file size for transmission. In some embodiments, the process 1400 packages these parameters into a firmware container or a configuration blob that includes versioning information. This generation step prepares the mathematical improvements for practical execution on resource-constrained hardware.

In additional embodiments, the process 1400 can push model updates to edge devices (block 1450). The process 1400 distributes the new model parameters over the air to the asset tags and access points located in the field. For example, the system might schedule the update to occur during off-hours to minimize network congestion and potential downtime. In some embodiments, the process 1400 utilizes a staged rollout strategy, updating a small subset of devices first to verify stability before broadcasting to the entire fleet. Once the updates are pushed, the process 1400 typically returns to the aggregation phase to begin monitoring the performance of the new model.

In alternative embodiments, the process 1400 can maintain current model configuration (block 1460). If the validation checks confirm that the current model is performing well, the process 1400 takes no action to alter the deployed logic. The process 1400 may log the successful validation event in an audit trail to demonstrate system reliability. In some embodiments, the process 1400 continues to accumulate data in the background without triggering a training run, building a larger dataset for future use. This maintenance state prevents the instability and bandwidth usage associated with unnecessary firmware updates.

Although a specific embodiment for a process 1400 for model training and updates suitable for carrying out the various steps, processes, methods, and operations described herein is discussed with respect to FIG. 14, any of a variety of systems and/or processes may be utilized in accordance with embodiments of the disclosure. For example, the process 1400 can be configured to train separate models for different facility types rather than a single global model. The elements depicted in FIG. 14 may also be interchangeable with other elements of FIGS. 1-13 and FIGS. 15-16 as required to realize a particularly desired embodiment.

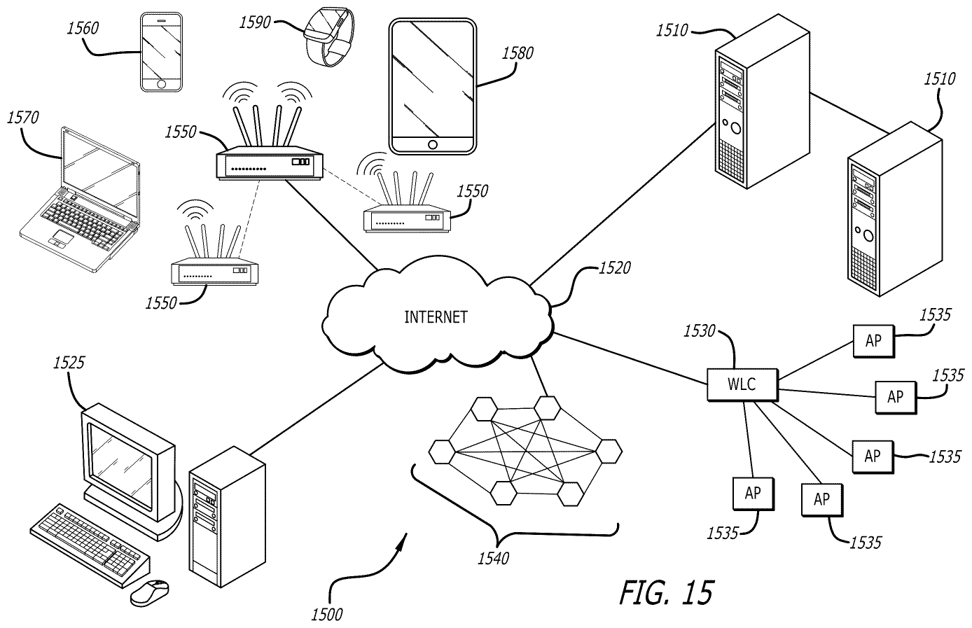

Referring to FIG. 15, a diagram illustrating a deployment environment 1500 for occupancy determination logic across local, edge, and remote layers in accordance with various embodiments of the disclosure is shown. In many embodiments, the deployment environment 1500 demonstrates the flexibility of the system architecture, enabling the core logic to be distributed across a wide range of computing platforms. This versatility ensures that the occupancy determination functions can be executed wherever the necessary computational resources or data streams are available. Furthermore, the deployment environment 1500 highlights how the same underlying algorithms can be scaled from running on a single battery-powered tag to executing on a massive cloud-based cluster.

In various embodiments, the remote server 1510 represents a high-performance computing resource located in a data center or cloud environment. The remote server 1510 is typically tasked with handling the most computationally intensive aspects of the system, such as training global machine learning models or aggregating historical data from thousands of sites. In some embodiments, the remote server 1510 executes the portions of the logic that require access to large-scale databases or third-party APIs that are not accessible to local devices. Additionally, the remote server 1510 serves as the central repository for firmware updates and configuration profiles that are pushed down to the edge components.

In a number of embodiments, the internet 1520 functions as the wide area network backbone connecting the disparate components of the system. The internet 1520 facilitates the secure transmission of telemetry data, control commands, and software updates between the local networks and the remote server 1510. By leveraging the internet 1520, the system can support multi-site deployments where a single dashboard manages facilities spread across different geographic regions. The internet 1520 also enables remote access for administrators, allowing them to monitor occupancy status and system health from any location with connectivity.

In many embodiments, the desktop computer 1525 represents a local administrative station or a dedicated on-premises server. The desktop computer 1525 may run a localized instance of the occupancy determination logic for facilities that require strict data sovereignty or operate without a reliable internet connection. In some embodiments, the desktop computer 1525 acts as a visualization terminal, rendering the real-time heatmaps and analytics dashboards for facility managers. The desktop computer 1525 can also serve as a local caching node, storing recent sensor data to reduce the bandwidth demands on the wide area network.

In further embodiments, the wireless local area network controller 1530 serves as the centralized management appliance for the wireless infrastructure within a building. The wireless local area network controller 1530 coordinates the operation of the access points, handling tasks such as radio resource management and client roaming. In certain embodiments, the wireless local area network controller 1530 executes a portion of the occupancy determination logic, particularly the aggregation of raw signal data from multiple receivers. This centralization at the edge allows the wireless local area network controller 1530 to make rapid decisions about network optimization based on real-time occupancy trends.

In additional embodiments, the access point 1535 acts as the primary wireless interface for the devices in the environment. The access point 1535 is capable of running lightweight inference models directly on its hardware, processing ultra-wideband or Bluetooth low energy signals at the source. By executing the occupancy determination logic at the edge, the access point 1535 reduces latency and network congestion, as only the final occupancy status needs to be transmitted upstream. The access point 1535 also serves as the anchor point for high-precision ranging, providing the accurate timestamps required for radar sensing.

In some embodiments, the distributed network 1540 illustrates a mesh or peer-to-peer topology where the logic is shared among multiple nodes. In the distributed network 1540, no single device acts as the central authority; instead, the occupancy determination logic is executed cooperatively by the connected devices. For example, a cluster of asset tags might share their sensor readings to form a consensus about the occupancy state of a room. This decentralized approach enhances the system's resilience, ensuring that monitoring continues even if a specific controller or server becomes unavailable.

In yet further embodiments, the gateway 1550 serves as a bridge between different network protocols or physical layers. The gateway 1550 may translate data from proprietary sensor protocols into standard IP-based packets for transmission over the internet 1520. In some embodiments, the gateway 1550 hosts a containerized version of the occupancy determination logic, allowing it to process data from legacy sensors or third-party devices. The gateway 1550 effectively decouples the sensor hardware from the upstream analytics platform, providing an abstraction layer that simplifies integration.

In various embodiments, the smartphone 1560 represents a personal mobile device that interacts with the system. The smartphone 1560 allows end-users to view occupancy data, locate assets, or even act as a mobile sensor itself. In some embodiments, the smartphone 1560 runs a client application that processes Bluetooth beacons to determine its own location within the facility. Additionally, the smartphone 1560 can provide validation data to the system, allowing users to manually confirm whether a room is truly occupied or empty to improve the model's accuracy.

In a number of embodiments, the laptop 1570 functions as a portable workstation that can access the system for configuration or monitoring purposes. The laptop 1570 enables technicians to perform site surveys, calibrate the reference tags, and troubleshoot signal coverage issues. In certain embodiments, the laptop 1570 can temporarily act as a local server, running the full occupancy determination stack during the initial setup phase before the permanent infrastructure is online. The mobility of the laptop 1570 makes it an essential tool for diagnosing issues in specific physical locations.

In many embodiments, the tablet 1580 serves as a dedicated display interface or kiosk for room booking and status display. The tablet 1580 is often mounted outside conference rooms to show real-time occupancy information derived from the system. In some embodiments, the tablet 1580 participates in the sensing network by listening for Bluetooth beacons from nearby asset tags. The tablet 1580 provides a tangible touchpoint for building occupants to interact with the smart space environment.

In some embodiments, the wearable device 1590 represents a compact, personal accessory that is integrated into the sensing ecosystem. The wearable device 1590, such as a smartwatch or badge, can function as an active asset tag, transmitting the signals required for tracking and occupancy detection. Because the wearable device 1590 is worn by a person, it provides highly reliable ground truth data regarding human presence. The wearable device 1590 may also deliver haptic notifications to the user based on the occupancy status, such as alerting a nurse when a patient room is entered.

Although a specific embodiment for a deployment environment 1500 for carrying out the various steps, processes, methods, and operations described herein is discussed with respect to FIG. 15, any of a variety of systems and/or devices may be utilized in accordance with embodiments of the disclosure. For example, the remote server 1510 could be replaced by a private cloud hosted entirely within the distributed network 1540. The elements depicted in FIG. 15 may also be interchangeable with other elements of FIGS. 1-14 and FIG. 16 as required to realize a particularly desired embodiment.

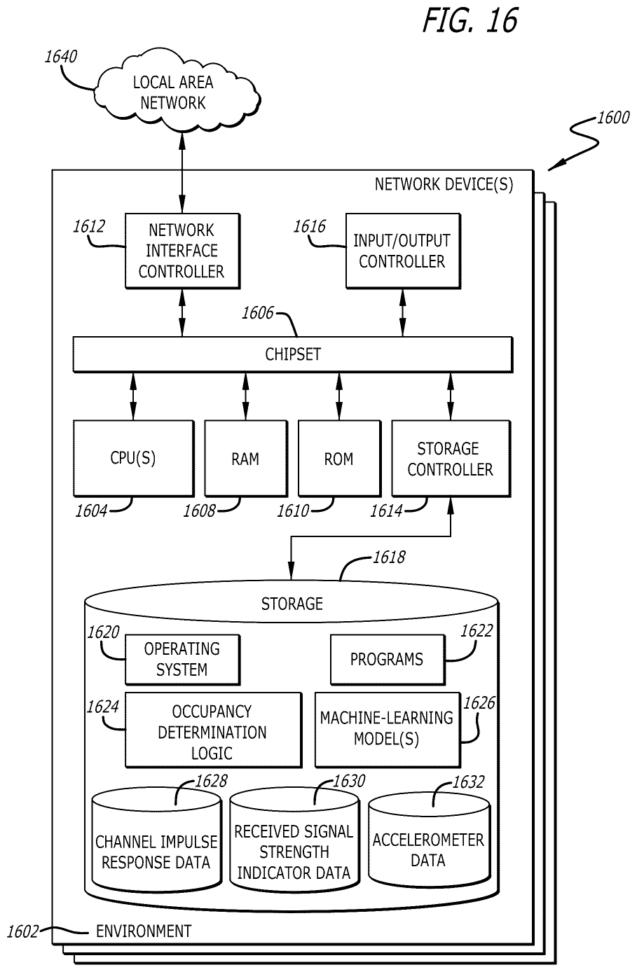

Referring to FIG. 16, a conceptual block diagram of a device 1600 suitable for configuration with an occupancy determination logic 1624 for implementing the functionality and various embodiments of the disclosure is shown. The embodiment of the device 1600 in the conceptual block diagram depicted in FIG. 16 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1600 may, in some examples, correspond to a physical device or to a virtual resource described herein. The device 1600 can be a network device, for example, an access point, a router, a switch, any type of edge-based network device, a server, a system, or the like in accordance with various embodiments of the disclosure.

In many embodiments, the device 1600 may include an environment 1602, which may represent the overall operational context or physical assembly, such as a baseboard or a “motherboard,” in physical embodiments that can be configured as a printed circuit board with a multitude of components or devices connected by way of a system bus or other electrical communication paths. Conceptually, in virtualized embodiments, the environment 1602 may be a virtual environment that encompasses and executes the remaining components and resources of the device 1600. In a number of embodiments, CPU(s) 1604 such as, but not limited to, Central Processing Units, can be configured to operate in conjunction with a chipset 1606. The CPU(s) 1604 can be standard programmable CPUs that perform arithmetic and logical operations that may support the operation of the device 1600.

In a variety of embodiments, the CPU(s) 1604 can perform one or more operations by transitioning from one discrete, physical state to the next through the manipulation of switching elements that differentiate between and change these states. Switching elements generally can include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 1606 may provide an interface between the CPU(s) 1604 and the remainder of the components and devices within the device 1600. The chipset 1606 can provide an interface to a Random-Access Memory (RAM 1608), which can be utilized as the main memory in the device 1600 in some embodiments. The chipset 1606 can further be configured to provide an interface to a computer-readable storage medium such as a Read-Only Memory (ROM 1610) or a Non-Volatile RAM (NVRAM) for storing basic routines that can help with various tasks such as, but not limited to, starting up the device 1600 and/or transferring information between the various components and devices. The ROM 1610 or NVRAM can also store other application components that may support the operation of the device 1600 in accordance with various embodiments described herein.

Different embodiments of the device 1600 can be configured to operate in a networked environment using logical connections to remote computing devices and computer systems through a network, such as the local area network 1640. The chipset 1606 can include functionality for providing network connectivity through a network interface controller 1612 (or NIC), which may include a gigabit Ethernet adapter, a high-speed SerDes interface, or similar component. The network interface controller 1612 can be capable of connecting the device 1600 to other devices over the local area network 1640. It is contemplated that a network interface controller 1612, or multiple, may be present in the device 1600, connecting the device 1600 to other types of networks and remote systems.

The device 1600 may also include other device(s) (not explicitly numbered but implied as connected to the input/output controller 1616 or system bus). In more embodiments, the device 1600 can be connected to a storage 1618 that provides non-volatile storage for data accessible by the device 1600. The storage 1618 can, for example, store an operating system 1620, applications or programs 1622, channel impulse response data 1628, received signal strength indicator data 1630, and accelerometer data 1632, which are described in greater detail below. The storage 1618 can be connected to the main system components through a storage controller 1614 connected to the chipset 1606 or system bus.

In additional embodiments, the storage 1618 can include one or more physical storage units. The storage controller 1614 can interface with the physical storage units through interfaces such as a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units. The device 1600 can store data within the storage 1618 by transforming the physical state of the physical storage units to reflect the information being stored.

The specific transformation of the physical state can depend on various factors. Examples of such factors can include, but are not limited to, the technology utilized to implement the physical storage units, whether the storage 1618 is characterized as primary or secondary storage, and the like. For example, the device 1600 can store information within the storage 1618 by issuing instructions through the storage controller 1614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description.

The device 1600 can further read or access information from the storage 1618 by detecting the physical states or characteristics of one or more particular locations within the physical storage units. In addition to the storage 1618 described above, the device 1600 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1600. In some examples, the operations performed by a cloud computing network, and or any components included therein, may be supported by one or more devices similar to the device 1600. Stated otherwise, some or all of the operations performed by a cloud computing network, and or any components included therein, may be performed by the device 1600 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1618 can store an operating system 1620 utilized to control the operation of the device 1600. According to one embodiment, the operating system 1620 includes the LINUX operating system. According to another embodiment, the operating system 1620 includes the Windows® server operating system from Microsoft Corporation. According to further embodiments, the operating system 1620 can include the UNIX operating system or one of its variants. It should be appreciated that other operating systems can also be utilized. The storage 1618 can store other system or application programs and data utilized by the device 1600.

In still more embodiments, the storage 1618 or other computer-readable storage media is encoded with computer-executable instructions which, when loaded into the device 1600, may transform the device 1600 from a general-purpose computing system into a special-purpose computer capable of implementing the embodiments described herein. These computer-executable instructions may be stored as applications or programs 1622 and transform the device 1600 by specifying how the CPU(s) 1604 can transition between states, as described above. In still further embodiments, the device 1600 has access to computer-readable storage media storing computer-executable instructions which, when executed by the device 1600, perform the various processes described with regard to the flowcharts of the present disclosure.

In still additional embodiments, the device 1600 can also include computer-readable storage media having instructions stored thereupon for performing any of the other computer-implemented operations described herein. In some more embodiments, the device 1600 can also include one or more input/output controller 1616 for receiving and processing input from a number of input devices, such as a keyboard, a mouse, a touchpad, a touch screen, an electronic stylus, or other type of input device. Similarly, an input/output controller 1616 can be configured to provide output to a display, such as a computer monitor, a flat panel display, a digital projector, a printer, or other type of output device. Those skilled in the art will recognize that the device 1600 may not include all of the components shown in FIG. 16, and can include other components that are not explicitly shown in FIG. 16, or may utilize an architecture completely different than that shown in FIG. 16.

As described above, the device 1600 may support a virtualization layer, such as one or more virtual resources executing on the device 1600. In some examples, the virtualization layer may be supported by a hypervisor that provides one or more virtual machines running on the device 1600 to perform functions described herein. The virtualization layer may generally support a virtual resource that performs at least a portion of the techniques described herein.

The occupancy determination logic 1624, in various embodiments, may represent a dedicated hardware circuit, a programmable logic device, a set of instructions executed by CPU(s) 1604, or a combination thereof, within the device 1600. This occupancy determination logic 1624 can be configured to manage and execute the multi-modal sensing operations of the system, including the coordination of Bluetooth and ultra-wideband radios to detect environmental changes. It is contemplated that occupancy determination logic 1624 can implement processes for triggering high-precision ranging based on low-power monitoring alerts, calculating the reflection points of bistatic radar signals, and updating the occupancy status of the monitored environment. In certain embodiments, the occupancy determination logic 1624 can actively monitor inputs such as channel impulse response data 1628, received signal strength indicator data 1630, and accelerometer data 1632 to make informed decisions regarding the presence of targets. For example, if received signal strength indicator data 1630 indicates a variance exceeding a threshold, the occupancy determination logic 1624 might trigger an active tracking session to confirm the presence of a person. Similarly, based on accelerometer data 1632, the occupancy determination logic 1624 could filter out signal variations caused by the device's own movement, ensuring that only true environmental occupancy events are reported to the network. The operations of occupancy determination logic 1624 may facilitate providing accurate, energy-efficient occupancy data to a cloud analytics service, which can then be utilized for space optimization.

The machine-learning model(s) 1626, in some embodiments, may represent a computational engine or a set of algorithms configured to learn from data and make predictions or decisions without being explicitly programmed for every specific scenario. This machine-learning model(s) 1626 can be executed by the CPU(s) 1604 or specialized hardware within device 1600 and may interact closely with the occupancy determination logic 1624. It is contemplated that the machine-learning model(s) 1626 could be trained using channel impulse response data 1628 that is historical or simulated, received signal strength indicator data 1630, accelerometer data 1632, and potentially other system performance metrics to identify complex patterns and correlations relevant to occupancy detection. In certain embodiments, the machine-learning model(s) 1626 can analyze incoming real-time data (channel impulse response data 1628, received signal strength indicator data 1630, accelerometer data 1632) and provide predictive insights or classification results to the occupancy determination logic 1624. For example, it might predict the number of people in a room based on the complexity of the multipath reflections (from channel impulse response data 1628) and the magnitude of signal attenuation (from received signal strength indicator data 1630), allowing the occupancy determination logic 1624 to update the headcount. Furthermore, the machine-learning model(s) 1626 could learn to distinguish between human breathing patterns and mechanical vibrations to reduce false positives, potentially adapting these settings over time as the system collects more training samples. This approach, leveraging a machine-learning model(s) 1626, can enable more sophisticated, adaptive, and potentially more accurate operation of the occupancy determination logic 1624 compared to traditional threshold-based methods.

The channel impulse response data 1628, in various embodiments, may encompass a range of time-domain measurements and parameters collected from the ultra-wideband transceiver within the device 1600. This data could include, for example, the complex amplitude and phase information of the received signal at various time delays, representing the multipath propagation environment. Channel impulse response data 1628 might also include information about the direct path arrival time, the strength of the first path component, or the delay spread of the reflections, which can be particularly relevant in environments with dense clutter or moving targets. In certain embodiments, the occupancy determination logic 1624 can utilize channel impulse response data 1628 as a key input for its decision-making processes associated with radar sensing and localization. By analyzing channel impulse response data 1628, the occupancy determination logic 1624 can assess the geometry of the reflections within the room. If, for example, channel impulse response data 1628 reveals a new peak that corresponds to a reflection from a human body, this information can trigger corrective actions by the occupancy determination logic 1624, such as calculating the coordinates of the target or updating the occupancy map to reflect the new position.

The received signal strength indicator data 1630, in many embodiments, may represent information pertaining to the signal power levels of Bluetooth low energy beacons or other wireless packets received by the device 1600. This data can include, but is not limited to, the attenuation values recorded over a specific time window, the variance of the signal strength, or the average power level relative to a calibrated baseline. Received signal strength indicator data 1630 might also reflect the proximity of other tags in the vicinity, indicating whether a zone is crowded or empty. It is contemplated that the occupancy determination logic 1624 can process received signal strength indicator data 1630 to anticipate or respond to changes in the environment that correspond to human presence. For example, if received signal strength indicator data 1630 indicates a sudden, sustained drop in signal power known as shadowing, the occupancy determination logic 1624 might interpret this as a person blocking the line of sight and trigger a confirmation scan. Conversely, if received signal strength indicator data 1630 shows stable, high-power readings, the logic might infer that the path is clear and maintain a low-power monitoring state to conserve energy, while ensuring that the system remains responsive to future changes. The use of received signal strength indicator data 1630 can thus enable more context-aware and efficient energy management by the occupancy determination logic 1624.

The accelerometer data 1632, in some embodiments, may consist of inertial readings and related information gathered from one or more motion sensors strategically placed within the device 1600. These sensors might monitor the orientation of the device, the magnitude of vibrations, or the detection of free-fall events. Accelerometer data 1632 can provide the occupancy determination logic 1624 with insights into the physical state of the asset tag and how it might be interacting with the environment. It is contemplated that the occupancy determination logic 1624 can utilize accelerometer data 1632 to implement motion filtering or state-based switching strategies. Since the movement of the tag itself can induce signal variances that mimic environmental occupancy, the occupancy determination logic 1624 can use accelerometer data 1632 to make corrective adjustments. For example, it might inhibit the occupancy detection algorithm when readings from accelerometer data 1632 indicate the device is in transit, thereby helping to maintain the integrity of the occupancy records, and this adjustment of the operating mode may further utilize such accelerometer data to switch between asset tracking and environmental sensing roles. This can contribute to the overall robustness and reliability of the device 1600.

Although a specific embodiment for a device 1600 suitable for configuration with the occupancy determination logic 1624 for carrying out the various steps, processes, methods, and operations described herein is discussed with respect to FIG. 16, any of a variety of systems and/or processes may be utilized in accordance with embodiments of the disclosure. For example, the occupancy determination logic 1624 could interface with additional types of sensor data beyond those explicitly shown, or the machine-learning model(s) 1626 could be implemented using a distributed architecture across multiple processing elements within device 1600. The elements depicted in FIG. 16 may also be interchangeable with other elements of FIGS. 1-15 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
an ultra-wideband transceiver; and
a memory communicatively coupled to the processor, wherein the memory comprises an occupancy determination logic that is configured to:
receive, via the ultra-wideband transceiver, a signal located in an environment;
extract a channel impulse response from the signal;
determine a difference between the channel impulse response to a baseline environmental signature associated with the environment;
detect, based on the difference, a multipath disturbance; and
update an occupancy status for the environment based on the multipath disturbance.

2. The network device of claim 1, wherein the signal is a blink signal.

3. The network device of claim 2, wherein the blink signal is transmitted by an asset tag.

4. The network device of claim 1, wherein the occupancy determination logic is further configured to apply a neural network model to analyze the difference between the channel impulse response and the baseline environmental signature to establish a correlation with a potential object in the environment.

5. The network device of claim 1, wherein the occupancy determination logic is further configured to:
identify a peak in the channel impulse response; and
correlate the peak with a specific physical area within the environment.

6. The network device of claim 1, wherein the occupancy determination logic is further configured to calculate a position of an object associated with the multipath disturbance by solving a set of non-linear equations using a known position of a source of the signal.

7. The network device of claim 1, wherein the occupancy determination logic is further configured to determine a headcount of occupants in the environment based on the multipath disturbance.

8. The network device of claim 1, wherein the network device comprises a plurality of antennas, and wherein the occupancy determination logic is further configured to:
receive the signal via the plurality of antennas; and
measure a signal arrival time for the signal at each of the plurality of antennas.

9. The network device of claim 8, wherein the occupancy determination logic is further configured to:
calculate a distinct position solution for an object for each of the plurality of antennas; and
compare the distinct position solution to determine an estimated position of the object.

10. The network device of claim 1, wherein the occupancy determination logic is further configured to continuously monitor variations in the channel impulse response over time to track a movement of an object within the environment.

11. An asset tag, comprising:
a processor;
an accelerometer;
a wireless transceiver; and
a memory communicatively coupled to the processor, wherein the memory comprises an occupancy detection logic that is configured to:
monitor inertial data generated by the accelerometer;
determine a stationary state based on the inertial data;
measure, via the wireless transceiver, signal characteristics of a wireless signal;
apply an onboard machine learning classification model to the signal characteristics wherein the onboard machine learning classification model is configured to generate an output;
determine an occupancy presence based on the output of the onboard machine learning classification model; and
transmit, via the wireless transceiver, an occupancy notification based on the occupancy presence.

12. The asset tag of claim 11, wherein measuring via the wireless transceiver occurs while in the stationary state.

13. The asset tag of claim 11, wherein the wireless signal is received from an external device.

14. The asset tag of claim 11, wherein the signal characteristics comprise at least one of a received signal strength indicator or channel state information.

15. The asset tag of claim 11, wherein the occupancy detection logic is further configured to adjust a sampling rate for measuring the signal characteristics based on a variance in the signal characteristics detected over a time window.

16. The asset tag of claim 15, wherein the occupancy detection logic is further configured to increase the sampling rate in response to the variance exceeding a predefined threshold.

17. The asset tag of claim 11, wherein the wireless transceiver comprises a Bluetooth Low Energy radio and an Ultra-Wideband radio, and wherein the occupancy detection logic is further configured to activate the Ultra-Wideband radio to transmit ranging signals upon determining the occupancy presence via the Bluetooth Low Energy radio.

18. The asset tag of claim 11, wherein the occupancy detection logic is further configured to initiate the measuring of the signal characteristics in response to receiving a trigger command from a network infrastructure device.

19. The asset tag of claim 11, wherein the onboard machine learning classification model comprises a decision tree model configured for execution on the processor.

20. A method of occupancy detection, comprising:
receiving, by a network device via an ultra-wideband transceiver, a signal located in an environment;
extracting, by the network device, a channel impulse response from the signal;
determining, by the network device, a difference between the channel impulse response to a baseline environmental signature associated with the environment;
detecting, by the network device, based on the difference, a multipath disturbance; and
updating, by the network device, an occupancy status for the environment based on the multipath disturbance.
